(19) United States
(12) Patent Application Publication
(10) Pub. No.: US 2026/0115061 A1
(43) Pub. Date: Apr. 30, 2026

(54) APPARATUS, SYSTEMS, AND METHODS FOR ENHANCING CONFIDENCE OF WHEELCHAIR SECUREMENT IN A VEHICLE

(71) Applicant: Valeda Company, LLC, Oakland Park, FL (US)

(72) Inventors: William Ott, Fort Lauderdale, FL (US); Patrick Girardin, Ft. Lauderdale, FL (US); Edgardo Cardona, Pompano Beach, FL (US); Ovidius Turcanu, Delray Beach, FL (US); Olinamyr Davalos, Ft. Lauderdale, FL (US); Daniel Tallitsch, Western springs, IL (US)

(73) Assignee: Valeda Company, LLC, Oakland Park, FL (US)

(21) Appl. No.: 19/367,465

(22) Filed: Oct. 23, 2025

Related U.S. Application Data
(60) Provisional application No. 63/711,757, filed on Oct. 25, 2024.
(60) Provisional application No. 63/740,535, filed on Dec. 31, 2024.

(51) Int. Cl. A61G 3/08

(52) U.S. Cl. CPC A61G 3/0808; A61G 2203/30; A61G 2220/14

(57) ABSTRACT

Apparatus, systems, and methods for sensing the status and configuration of various accessibility devices in a vehicle, monitoring and reporting the status and configuration of those accessibility devices, guiding a vehicle operator or attendant through the proper use of those accessibility devices, and identifying and reporting abnormal conditions based on feedback from those devices are provided herein. These systems provide enhanced securement confirmation for a vehicle operator and promote a safer riding experience for a mobility passenger.

### CROSS REFERENCE TO OTHER APPLICATIONS

This application claims priority to U.S. Provisional Patent Application Nos. 63/711,757, filed on Oct. 25, 2024, and 63/740,535, filed on Dec. 31, 2024, the contents of which are incorporated herein by reference. This application also incorporates by reference the contents of PCT Patent Application No. PCT/US25/52269, filed on Oct. 23, 2025, U.S. Patent Publ. No. 2023/0048271, published on Feb. 16, 2023, U.S. Patent Publ. No. 2024/0173180, published on May 30, 2024, and U.S. Pat. No. 10,071,004, issued on Sep. 11, 2018.

### FIELD OF THE DISCLOSURE

The present disclosure relates generally to a passenger vehicle that has been modified to transport a physically limited passenger seated in a wheelchair and, more particularly but not limited to, apparatus, systems, and methods for sensing the status and configuration of various accessibility devices in a vehicle, monitoring and reporting the status and configuration of those accessibility devices, guiding a vehicle operator or attendant through the proper use of those accessibility devices, and identifying and reporting abnormal conditions based on feedback from those devices.

### BACKGROUND

This section introduces aspects that may help facilitate a better understanding of the disclosure. Accordingly, these statements are to be read in this light and are not to be understood as admissions about what is or is not prior art.

Automobile manufacturers do not currently mass produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by installing parts specifically designed to accommodate the physically limited passenger. The most important part of outfitting an accessible vehicle is keeping the passenger safe during operation of the vehicle. Many physically limited passengers will use a personal mobility device (PMD) to move around outside of the vehicle. Some passengers are able to transfer from their PMD to the vehicle seat, but for those who cannot, the accessible vehicle outfitter needs to secure the PMD with the passenger seated in the PMD inside the vehicle.

Systems have been developed and employed to secure PMDs and PMD- bound occupants (referred to herein as mobility passengers). These systems are typically comprised of occupant restraints that include at least one shoulder belt along with one or more lap belts. They may also include some form of PMD securement that could comprise one or more tie-downs (e.g., belts), bumpers, barriers, docks, latches, automated grippers, or any combination thereof. These systems have proven successful in meeting occupant stability needs and basic crash test requirements; however, that is only when used properly. Many vehicles are modified to be passenger transport vehicles where the driver would apply the securement system on the PMD and mobility passenger. Inexperienced vehicle operators may not know the requirements to secure a mobility passenger properly, leaving them vulnerable to injuries in a harsh driving environment.

Therefore, there is an unmet need for confirmation that a securement system is properly applied to a mobility passenger before operating the vehicle for their safety.

### SUMMARY OF THE EMBODIMENTS

To meet these needs, a system may be provided for securing a wheelchair in a vehicle, the system comprising a camera that may be configured to capture image data of the wheelchair, at least one tiedown that may be configured to secure the wheelchair, and a computing device. The computing device may be configured to receive image data from the camera, identify from the image data a connection point on the wheelchair and the tiedown (which may include identifying a connection member such as a hook), and determine whether the tiedown is engaged with the connection point on the wheelchair. This identification may be enhanced by applying a machine learning algorithm. The system may further include a user interface, wherein the computing device may be configured to provide status cues (indicating secured or unsecured conditions), instructional cues (for subsequent securement steps or for correcting engagement), and troubleshooting cues via the user interface based on the engagement determination. These cues may be presented as overlays on representations (which may include the captured image data) of the wheelchair or tiedown, or as auditory or haptic feedback. Furthermore, the computing device may be configured to apply an interlock preventing vehicle operation, store image data, or request and store an acknowledgement of an incorrect connection, upon determining that the tiedown is not engaged. A corresponding method for securing a wheelchair in a vehicle may also be provided, involving steps that may include capturing image data, receiving and processing this data by a computing device to identify connection points and tiedowns, determining their engagement, and subsequently generating various cues, applying interlocks, storing data, or requesting acknowledgements as described for the system.

In another embodiment, a system may be provided for verifying occupant securement in a vehicle. The system may comprise a camera configured to capture image data of an occupant and a computing device coupled to the camera. The computing device may be configured to receive the image data, identify from the image data an occupant belt and a passenger (potentially using a machine learning algorithm), and determine the position of the occupant belt relative to the passenger. This determination may involve assessing if a lap belt is correctly positioned across the pelvis and hips or not over wheelchair armrests, and if a shoulder belt is positioned across the chest, away from the neck, not behind the back or under an arm, and considering its angle and alignment with the passenger's height. The computing device may then determine whether this position meets predetermined criteria for proper securement. A user interface may be included, where the computing device may cause it to provide a status cue for a secured condition or an alert (such as a troubleshooting or instructional cue, which may be visual, auditory, or haptic) if the position is improper. The system may also apply an interlock preventing vehicle operation, store image data, or request and store an acknowledgement of an improper position if the securement is not proper. A corresponding method for verifying occupant securement in a vehicle is also contemplated.

In another embodiment, a system may be provided for monitoring securement integrity of a wheelchair during transit in a vehicle. The system may comprise at least one sensor configured to obtain data indicative of one or more securement parameters of a wheelchair securement system, and a controller coupled to the sensor. The controller may be configured to establish a pre-departure baseline value for the securement parameter(s) prior to vehicle departure, obtain current values during vehicle operation, and determine whether these current values are within an adaptive envelope based on the pre-departure baseline. The controller may generate an alert if the current values fall outside this adaptive envelope. The system may also be configured to determine if the pre-departure baseline itself is within a predetermined ideal envelope, generating alerts or applying interlocks if it is not. Such alerts may include visual, auditory, or haptic cues, status cues, troubleshooting cues, or instructional cues, and interlocks may prevent vehicle operation until an out-of-specification parameter is corrected or an acknowledgement is received.

In another embodiment, a system may be provided for guiding a wheelchair passenger into a desired or optimal location for securement in a wheelchair securement system in a vehicle. The system can include a user interface and a computing device coupled to the user interface. The computing device may be configured to receive a signal indicative of a location of the wheelchair passenger and cause the user interface to generate at least one directional cue. The at least one directional cue may be based upon the location of the wheelchair passenger and the desired location for securement.

In another embodiment, a system may be provided for guiding a wheelchair passenger up or down a ramp of a vehicle. The system may include a user interface and a computing device coupled to the user interface. The computing device may be configured to receive a signal indicative of a location of the wheelchair passenger and cause the user interface to generate at least one directional cue. The at least one directional cue may be based upon the location of the wheelchair passenger and at least one of a location of a center line of the ramp and a location of a side rail of the ramp. The system may include, and be integrated with the ramp.

In another embodiment, a system may be provided for ensuring compliance with a weight limit for a wheelchair securement system in a vehicle. The system may include a user interface and a computing device coupled to the user interface. The computing device may be configured to receive a signal indicative of a weight of a wheelchaired passenger and cause the user interface to generate at least one status cue based on a comparison between the weight of the wheelchaired passenger and the weight limit of the wheelchair securement system. The computing device may be further configured to at least one of activate or deactivate the wheelchair securement system based on the comparison between the weight of the wheelchaired passenger and the weight limit of the wheelchair securement system.

In another embodiment, a system may be provided for selecting between a first wheelchair securement system and a second wheelchair securement system in a vehicle based on a weight of a wheelchaired passenger, wherein the first wheelchair securement system has a first weight limit, wherein the second wheelchair securement system has a second weight limit, and wherein the first weight limit is greater than the second weight limit. The system may include a user interface and a computing device coupled to the user interface. The computing device may be configured to receive a signal indicative of the weight of the wheelchaired passenger. Where the weight of the wheelchaired passenger is less than the first weight limit but exceeds the second weight limit, the computing system may at least one of activate the first wheelchair securement system or deactivate the second wheelchair securement system. The computing device may be further configured to cause the user interface to generate a directional cue directing the wheelchaired passenger to the first wheelchair securement system.

In another embodiment, a system may be provided for activating a wheelchair securement system in a vehicle based on the presence of a wheelchaired passenger in a securement floor area, wherein the wheelchair securement system comprises at least one sensor configured to detect a weight on the securement floor area. The system may include a user interface and a computing device coupled to the user interface. The computing device may be configured to receive a signal indicative of the weight on the securement floor area from the sensor. Where the weight on the securement floor area satisfies a predetermined threshold indicative of the presence of the wheelchaired passenger, the computing device may cause the user interface to provide an instructional cue instructing the individual to secure at least one securement of the wheelchair securement system.

In another embodiment, a system may be provided for activating a wheelchair securement system in a vehicle based on the presence of a wheelchaired passenger in a securement floor area. The system may include a user interface and a computing device coupled to the user interface. The computing device may be configured to determine whether the wheelchair passenger is present in the securement floor area and automatically cause the user interface to provide an instructional cue instructing the individual to secure at least one securement of the wheelchair securement system if the wheelchair passenger is determined to be present. The computing device may determine whether the wheelchair passenger is present in the securement floor area by applying a machine learning algorithm to a signal received from a perception sensor.

In another embodiment, a system for determining that a wheelchaired passenger has occupied a wheelchair securement system in a vehicle, wherein the wheelchair securement system comprises at least one sensor configured to detect a weight on a securement floor area. The system may include a user interface and a computing device coupled to the user interface and configured to receive a signal indicative of the weight on the securement floor area from the sensor. Where the weight on the securement floor area from the sensor satisfies a predetermined threshold indicative of the presence of the wheelchaired passenger, the computing device may cause the user interface to provide an status cue reflecting that the wheelchair securement system is occupied.

In another embodiment, a system may be provided for instructing an individual on securing a wheelchaired passenger in a wheelchair securement system in a vehicle, wherein the wheelchair securement comprises at least a first securement and a second securement for securing a wheelchair in the vehicle. The system may include a user interface and a computing device coupled to the user interface. The computing device may be configured to cause the user interface to provide an instructional cue instructing an individual to secure the first securement to the wheelchair and cause the user interface to provide an instructional cue instructing the individual to secure the second securement to the wheelchair. In some implementations, the computing device may be further configured to receive a feedback signal reflecting a parameter of at least one of the first securement and the second securement and cause the user interface to provide a troubleshooting cue if the parameter falls outside a predetermined threshold In some implementations, the computing device may be further configured to receive feedback signal reflecting a parameter of at least one of the first securement and the second securement; and cause the user interface to provide a status cue indicative of the parameter. In some implementations, the computing device may be further configured to receive feedback relating to a parameter of at least one of the first securement and the second securement and cause the user interface to provide the instructional cue instructing the individual to secure the second securement to the wheelchair only after confirming that the parameter falls inside a predetermined threshold. In some implementations, the user interface comprises a first illumination device associated with the first securement and a second illumination device associated with the second securement, the computing device causes the user interface to provide the instructional cue instructing an individual to secure the first securement to the wheelchair by illuminating the first illumination device, and the computing device causes the user interface to provide the instructional cue instructing the individual to secure the second securement to the wheelchair by illuminating the second illumination device. In some implementations, the first illumination device is disposed on the first securement and the second illumination device is disposed on the second securement.

In another embodiment, a system may be provided for instructing an individual on securing a wheelchaired passenger in a wheelchair securement system in a vehicle, wherein the wheelchair securement system comprises at least one securement. The system may include a user interface and a computing device coupled to the user interface. The computing device may be configured to receive an input indicative of a location of a tiedown connection point on a wheelchair and based on the input, cause the user interface to provide an instructional cue identifying the location of the tiedown connection point on the wheelchair where the individual should secure the at least one securement.

In another embodiment, a system may be provided for instructing an individual on securing a wheelchaired passenger in a wheelchair securement system in a vehicle, wherein the wheelchair securement system comprises at least one securement. The system may include a user interface and a computing device coupled to the user interface. The computing device may be configured to identify a location of a tiedown connection point on a wheelchair and cause the user interface to provide an instructional cue identifying the location of the tiedown connection point on the wheelchair where the individual should secure the at least one securement.

In another embodiment, a system may be provided for saving at least one image reflecting securement of a wheelchaired passenger in a wheelchair securement system in a vehicle, wherein the wheelchair securement system comprises at least one securement. The system may include a computing device configured to receive a feedback signal indicative of the at least one securement being applied to the wheelchaired passenger, capture the at least one image, and store the at least one image in a memory. In some implementations, the computing device captures the at least one image automatically in response to receiving the feedback signal. In some implementations, the at least one image depicts an interface between the securement and the wheelchaired passenger. In some implementations, the wheelchair passenger comprises a wheelchair and a passenger and the at least one image depicts the interface between the securement and at least one of the wheelchair and the passenger.

In another embodiment, a system may be provided for saving at least one image reflecting securement of a wheelchaired passenger in a wheelchair securement system in a vehicle. The system may include a user interface and a computing device coupled to the user interface. The computing device may be configured to cause the user interface to provide an instructional cue prompting an individual to capture the at least one image, receive the at least one image, and store the at least one image in a memory. In some implementations, the wheelchair securement system comprises at least one securement and the computing system automatically causes the user interface to provide the instructional cue prompting the individual to capture the at least one image in response to receiving a feedback signal indicative of the at least one securement being applied to the wheelchaired passenger.

In another embodiment, a system may be provided for saving at least one image reflecting securement of a wheelchaired passenger in a wheelchair securement system in a vehicle, wherein the wheelchair securement system comprises at least one securement. The system may include a computing device configured to receive a feedback signal indicative of an adverse condition that may affect a safety of securement of the wheelchaired passenger, automatically capture the at least one image in response to the feedback signal, and store the at least one image in a memory.

In another embodiment, a system may be provided for interlocking use of a vehicle until an individual provides an acknowledgement of a non-or non-standard use of at least one component of a wheelchair securement system by a wheelchaired passenger in a vehicle. The system may include a computing device configured to apply an interlock preventing use of the vehicle, receive a feedback signal indicative of the non-or non-standard use of the at least one component of the wheelchair securement system, and prevent release of the interlock until the acknowledgement reflecting the individual's knowledge of the non-or non-standard use of the at least one component of the wheelchair securement system is received.

In another embodiment, a system may be provided for obtaining an acknowledgement that an individual is knowledgeable concerning a non-or non-standard use of at least one component of a wheelchair securement system by a wheelchaired passenger in a vehicle. The system may include a user interface and a computing device coupled to the user interface. The computing device may be configured to receive a feedback signal indicative of the non-or non-standard use of the at least one component of the wheelchair securement system, cause the user interface to provide a warning reflecting the non-or non-standard use of the at least one component of the wheelchair securement system, receive the acknowledgement that the individual is knowledgeable concerning the non-or non-standard use, and store the acknowledgement in a memory. In some implementations, the computing device is further configured to receive at least one image reflecting the non-or non-standard use of the at least one component of the wheelchair securement system and to store the at least one image in memory. In some implementations, the computing device automatically captures the at least one image reflecting the non-or non-standard use of the at least one component of the wheelchair securement system. In some implementations, the computing device is further configured to receive at least one image reflecting an identity of the individual providing the acknowledgement. In some implementations, the computing device automatically captures the at least one image reflecting the identity of the individual providing the acknowledgement.

In another embodiment, a system may be provided for providing real-time feedback from a wheelchair securement system in a vehicle, the wheelchair securement system comprising at least one securement. The system may include a user interface and a computing device coupled to the user interface. The computing device may be configured to receive a first feedback signal from a first sensor detecting a first parameter of the at least one securement, receive a second feedback signal from a second sensor detecting a second parameter of the at least one securement, determine a status of the at least one securement based on the first feedback signal and the second feedback signal, the status being defined by whether the at least one securement is in a secured condition or an unsecured condition, and cause the user interface to generate at least one status cue reflecting at least one of the status, the first feed back signal, and the second feedback signal. In some implementations, the at least one securement is a tiedown retractor with a strap and a hook. In some implementations, the computing device is further configured to: compare the first parameter with a first predetermined threshold; and cause the user interface to generate a troubleshooting cue if the first parameter fails to satisfy the predetermined threshold. In some implementations, the computing device is further configured to: compare the second parameter with a second predetermined threshold; and cause the user interface to generate a troubleshooting cue if the second parameter fails to satisfy the second predetermined threshold. In some implementations, the at least one status cue reflects the status. In some implementations, the at least one status cue reflects the first parameter. In some implementations, the first parameter is a position of a locking mechanism for the tiedown retractor. In some implementations, the second parameter reflects a length of the strap; and the computing device is further configured to prevent the tiedown retractor from moving to the locked condition if the second parameter fails to satisfy the second predetermined threshold. In some implementations, the first parameter reflects whether the hook is stored. In some implementations, the second sensor is a counter operably coupled to the strap, whereby the second parameter reflects a length of the strap; and the counter resets when the first parameter reflects that the hook of the tiedown retractor is stored. In some implementations, the first parameter reflects a length of the strap. In some implementations, the first parameter reflects an angle of the strap. In some implementations, the at least one securement comprises a first securement and a second securement, the first sensor detect the first parameter of the first securement, and the second sensor detects the second parameter of the second securement. In some implementations, the computing device is further configured to: determine a differential between the first parameter and the second parameter; and cause the user interface to generate a troubleshooting cue if the differential fails to satisfy a predetermined threshold. In some implementations, each of the first securement and the second securement comprises a tiedown retractor with a strap, the first parameter is a length of the strap of the first securement, and the second parameter is a length of the strap of the second securement. In some implementations, the at least one securement is an occupant belt assembly comprising a tongue, a buckle, and at least one retractor with a belt. In some implementations, the first parameter reflects a length of the belt. In some implementations, the second parameter reflects whether the tongue is engaged with or disengaged from the buckle.

In another embodiment, a system may provide real-time feedback from a wheelchair securement system in a vehicle, the wheelchair securement system comprising an tiedown assembly having a tiedown retractor with a strap. The system may include a user interface and a computing device coupled to the user interface. The computing device may be configured to receive a first feedback signal from a first sensor detecting a length of the strap and cause the user interface to generate at least one status cue reflecting a secured status of the tiedown assembly if the length of the strap satisfies a predetermined length threshold for a predetermined time threshold.

In another embodiment, a system may receive real-time feedback from a wheelchair securement system in a vehicle, the wheelchair securement system comprising an occupant belt assembly having a tongue, a buckle, and at least one retractor with a belt. The system may include a user interface and a computing device coupled to the user interface. The computing device may be configured to receive a first feedback signal from a first sensor detecting a length of the belt and cause the user interface to generate at least one status cue reflecting a secured status of the occupant belt assembly if the length of the belt satisfies a predetermined length threshold for a predetermined time threshold.

In another embodiment, a system may be provided for detecting at least one abnormality affecting the performance of a wheelchair securement system in a vehicle. The system may include a user interface and a computing device coupled to the user interface. The computing device may be configured to receive at least one feedback signal from at least one sensor detecting at least one parameter indicative of the at least one abnormality and cause the user interface to generate at least one troubleshooting cue if the at least one parameter fails to satisfy at least one predetermined threshold. In some implementations, the computing device is further configured to send a signal for deactivating the wheelchair securement system if the at least one parameter fails to satisfy the at least one predetermined threshold. In some implementations, the at least one parameter comprises a temperature of at least one of a securement for the wheelchair securement system, an interior of the vehicle, and an exterior of the vehicle. In some implementations, the at least one parameter comprises a stiffness of a strap or belt of the wheelchair securement system. In some implementations, the at least one parameter comprises an acceleration of at least one of the vehicle and a wheelchaired passenger. In some implementations, the at least one parameter comprises a slack in a strap or belt of the wheelchair securement system.

Any of the foregoing systems may be integrated into the wheelchair securement system and/or the vehicle.

In another embodiment, a vehicle is outfitted with a wheelchair tiedown and occupant restraint system, or WTORS. The WTORS may comprise one or more retractors. The one or more retractors may include a hooking device configured to attach to a wheelchair of a mobility passenger. The hooking device may be coupled to a strap. The strap may be retracted into a spool within the retractor when not in use.

In one example of this embodiment, a retractor may have a locking mechanism that may move between a locked and an unlocked position. The retractor may include a sensor to determine the position of the locking mechanism. The sensor may be a photoelectronic sensor, ultrasonic sensor, a ToF sensor, a magnet sensor wherein the locking mechanism may have one or more magnets coupled to it or be made of a magnetic material detectable by a magnet sensor, or any other known types of sensors for determining the presence of an object. The sensor may be positioned to determine either if the locking mechanism is in the locked position or the unlocked position.

In another example of this embodiment, the retractor may include a pulley. During the process of securing a mobility passenger, the operator may pull the hooking device, and therefore the strap, out from the spool to attach to the wheelchair. The strap may pass over a pulley. The pulley may be coupled to a sensor that is able to measure the rotation of the pulley. The sensor may be an encoder, a ToF sensor, a rotary position sensor, a magnet sensor wherein the pulley has one or more magnets coupled to it, or any other known method of measuring rotation. This sensor may then be configured based on the size of the pulley to convert to distance of strap that is deployed.

In another example of this embodiment, the strap may include a pattern that is readable by a sensor to determine how much distance of the strap is pulled out.

In another example of this embodiment, the retractor may store the strap in a spool. A sensor may be configured to measure the rotation of the spool. The sensor may be an encoder, a ToF sensor, a rotary position sensor, a magnet sensor wherein the spool has one or more magnets coupled to it, or any other known method of measuring rotation. The sensor, or an external controller, may then be programmable to convert the spool rotation to distance of strap that is deployed. This conversion may include a mathematical formula since as the strap is pulled out of the spool, the outer radius of the spool decreases so a constant rotation to distance conversion would not be accurate.

In another example of this embodiment, a sensor may be coupled to the retractor to determine if the hooking device is in the stowed position. The hooking device may have a nesting location in the WTORS such that when the WTORS is not in use, it is nested in the floor to prevent a tripping hazard for ambulatory passengers. The sensor may be a photoelectronic sensor, ultrasonic sensor, a ToF sensor, a weight sensor, a magnet sensor wherein the hooking device may have one or more magnets coupled to it or be made of a magnetic material detectable by a magnet sensor, or any other known types of sensors for determining the presence of an object. A hook storage sensor may be especially useful in a WTORS that uses more than one retractors. The sensor may be positioned in the nesting location to detect the hooking device, or may be on the retractor to detect the strap approximate the hooking device.

In another example of this embodiment, the retractor may include an angle sensor. The angle sensor may be coupled to the hooking device or on the strap near the hooking device. The angle sensor may be utilized for determining if the hooking device is in storage. For example, if the angle sensor is reading an angle at or about 0°, the controller may determine that the hooking device is in a stowed position. The angle sensor may further be used to confirm proper deployment of the retractor. WTORS may have an acceptable angle of attack of the strap of a retractor attaching to a wheelchair based on testing. A proper angle reading may assist to confirm proper application of the retractor.

In another example of this embodiment, the WTORS may be a structure that is mounted within the floor of a vehicle and may include a sensor to determine the presence of a mobility passenger. The sensor may be a weight sensor, photoelectronic sensor, ToF sensor, ultrasonic sensor, camera, or any other known method of sensing the presence of an object. The mobility passenger sensor may be configured to send a signal to a controller. The controller may then be configured to display an indication of when a mobility passenger is present.

In another example of this embodiment, a controller may be provided to read the signals of the one or more sensors previously mentioned in various embodiments. The controller may be integrated into the retractor. The controller may alternatively be integrated into a WTORS that contains more than one retractor, and the controller may be configured to communicate with each retractor. The controller may alternatively be integrated into the vehicle electronic system. The controller may be electrically connected to each sensor and configured to receive a signal indicative of what each sensor may read. The controller may be programmable to execute logic to determine if each sensor signal is an acceptable reading. The acceptable signals may be a range of values determined by safety testing. The controller may then be configured to send a signal to an indicator. The indicator may be configured to display if the retractor has been properly applied to a wheelchair and communicate if the driving condition is safe or not safe. The indicator may also indicate if the hooking device of the retractors are properly stored when no mobility passenger is present to prevent a hazard for ambulatory passengers. The indicator may be a light that changes color, green meaning safe driving condition and red meaning unsafe driving condition, for example. The indicator may alternatively be a screen with a text warning of the unsafe condition. The screen may indicate which sensor on which retractor is reading a value outside the acceptable reading. This may assist an inexperienced operator to not forget one retractor when there are multiple in a WTORS. Alternatively, the controller may be integrated with the vehicle to issue a display warning for the driving condition on a screen on the dashboard of the vehicle. Further, the indicator may be tied-into the vehicle controls to “lock out” driving controls when the controller determines an unsafe driving condition.

In another example of this embodiment, a WTORS may have at least one retractor in the front of the mobility passenger and at least one retractor in the rear of the mobility passenger. In this configuration the controller may ascertain a value from the angle sensor and the strap deployment sensor. The controller may then use the Pythagorean Theorem to calculate a projected distance of the strap in a planar distance on the floor for both retractors. The controller may further ascertain the length of the wheelchair of the mobility passenger from the mobility passenger presence sensor. The controller may add up the distances from the projected strap distances and the length of the wheelchair. The controller may be programmed to compare this calculated distance to a programmed distance corresponding to the installed distance between the two retractors. If the calculated distance is significantly different than the programmed install distance between retractors, the controller may determine an improper securement condition.

In another example of this embodiment, the wheelchair of the mobility passenger may have brackets configured to receive a hook from a retractor of a WTORS. The wheelchair may be configured to communicate with the WTORS to ensure the hooks are properly applied to the hook brackets. The wheelchair may have sensors configured to read the presence of an object attached to the hook brackets. The sensor may be a photoelectronic sensor, ultrasonic sensor, a ToF sensor, a weight sensor, a magnet sensor wherein the hooking device may have one or more magnets coupled to it or be made of a magnetic material detectable by a magnet sensor, or any other known types of sensors for determining the presence of an object. Alternatively, the hook may be electrically powered such that connection to the hook would ground the circuit and indicate it is connected to the proper bracket.

In another embodiment, a wheelchair securement system may be provided for securing a wheelchair in a vehicle, comprising a set of two tiedowns (a first tiedown with a first connection member and a second tiedown with a second connection member), a bumper configured to contact the wheelchair, a camera configured to capture image data of the wheelchair in a securement area, and a computing device. The computing device may be configured to receive the image data, identify from the image data a first connection point on the wheelchair and the first connection member, a second connection point on the wheelchair and the second connection member, and the wheelchair and the bumper. The computing device may then determine whether the first connection member is engaged with the first connection point, whether the second connection member is engaged with the second connection point, and whether the bumper is in contact with the wheelchair. The camera may be specifically configured to capture image data of the rear portion of the wheelchair, with the connection points being rear right and rear left, and the bumper may be configured to contact the rear portion. Machine learning algorithms may be applied to identify these components. The system may further include a user interface, and the computing device may be configured to provide a status cue indicating a secured condition if all components are properly engaged and in contact, or provide an alert (which may be visual, auditory, or haptic, and comprise a status, troubleshooting, or instructional cue) if any component is not properly secured. The system may also apply an interlock preventing vehicle operation if securement is improper, prevent its release until an acknowledgement is received, and store image data of improper securement. Corresponding methods for securing a wheelchair in a vehicle by utilizing image data to identify and verify these components and their engagement are also contemplated.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a diagrammatic view of an exemplary system 1000 for, among other things, sensing the status and configuration of various accessibility and non-accessibility devices in a vehicle 1100, monitoring and reporting the status and configuration of those devices, guiding a vehicle operator or attendant on the use of those devices, and identifying and reporting abnormal conditions based on feedback from those devices.

FIG. 2 is an exemplary user interface 1020 for the system 1000 of FIG. 1 that displays the status and configuration of the various accessibility and non-accessibility devices in the vehicle 1100.

FIG. 3 is an exemplary user interface 1020 for the system 1000 of FIG. 1 that displays directional cues for properly positioning a mobility passenger in a wheelchair securement system 1300.

FIG. 4 is an exemplary user interface 1020 for the system 1000 of FIG. 1 that displays instructional, status, and troubleshooting cues for properly securing a mobility passenger in a wheelchair securement system 1300.

FIG. 5 is an exemplary wheelchair tiedown and occupant restraint system (WTORS).

FIG. 6 is a perspective view of an improved retractor which forms a part of the WTORS of FIG. 5.

FIGS. 7 and 8 are detail views of the improved retractor of FIG. 4.

FIG. 9 is an illustrative example of a network electrical connection of sensors in a WTORS.

FIG. 10 is a flowchart of logic a programmable controller may use to determine if a vehicle with a WTORS is safe to operate.

FIG. 11 is an exemplary representation of image data captured by a camera showing the rear of a wheelchair with a passenger while secured in a vehicle with a tiedown attached to a designated connection point on the wheelchair.

FIG. 12 is a top view illustrating a two-point wheelchair securement system with a bumper, suitable for integration with the vision-based verification system described herein.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

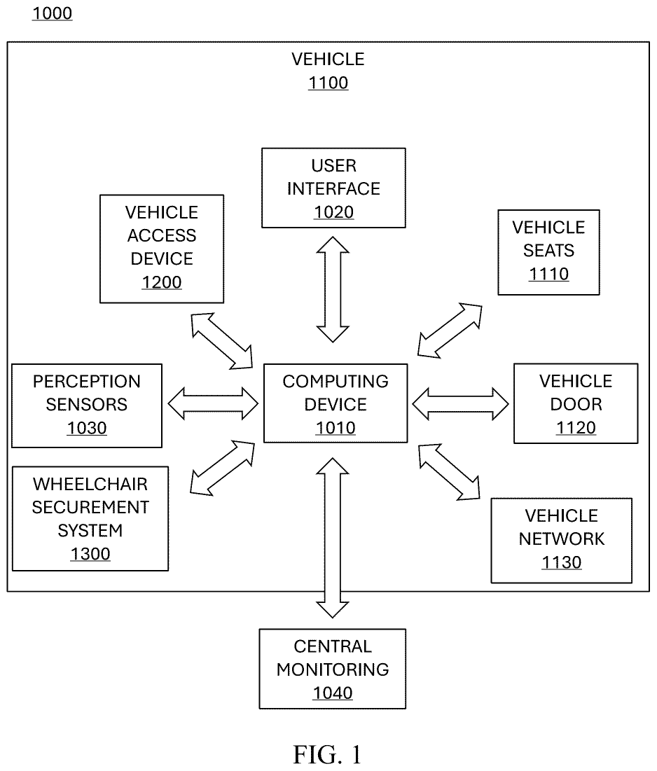

FIG. 1 illustrates an exemplary system 1000 for, among other things, sensing the status and configuration of various accessibility and non-accessibility devices in a vehicle 1100, monitoring and reporting the status and configuration of those devices, guiding a vehicle operator or attendant on the use of those devices, and identifying and reporting abnormal conditions based on feedback from those devices.

The system 1000 may comprise a computing device 1010 that is, for example, conventionally configured with a processor for performing various functions and executing code, memory for storing, among other things, the code, and communications devices and adapters for communicating through any desired medium, wired or wireless. The memory may also store historical data regarding the system, including but not limited to the status and configuration of the connected devices (e.g., any and all directional cues, instructional cues, status cues, troubleshooting cues, images, etc., including those described below, particularly in the event of an incident or accident). In the event of an incident, an individual can review the historical data stored in memory, for example, to determine the exact moment the incident occurred and see the securement status at that time. The individual can also review the steps taken to secure the passenger, along with vehicle dynamics at the time of the incident. Although depicted on the vehicle 1100, the computing device 1010 may be disposed on or remote from the vehicle 1100. The computing device 1010 may comprise multiple computing devices, all disposed on the vehicle 1100, all disposed remote from the vehicle 1100, or some on the vehicle 1100 and some remote therefrom.

Notwithstanding the previous paragraph, it is to be understood that the term ‘computing’ as used throughout this disclosure is intended to be interpreted broadly and is not limited to a device having a processing unit. For example, the computing device may take form as a controller, for example a programmable device such as a microprocessor, a microcontroller, a Programmable Logic Controller (PLC), an Application-Specific Integrated Circuit (ASIC), or a Field-Programmable Gate Array (FPGA). Furthermore, the control logic described herein need not be executed by a programmable device. In other embodiments, the controller may be implemented as a hard-wired system comprising an arrangement of electromechanical relays, solid-state switches, solenoids, and other discrete electronic components configured to perform the necessary logical operations. Essentially, the computing device, also referred to herein as a controller, encompasses any hardware, firmware, software, or combination thereof capable of receiving input signals from sensors and operator controls and, based on a predefined set of rules, providing output signals to perform functions described herein.

The computing device 1010 may be adapted for unidirectional or bidirectional communication with various devices, both on or remote from the vehicle 1100, including but not limited to one or more of a user interface 1020, a vehicle network (e.g., CAN or other vehicle network) 1130, vehicle seats 1110, vehicle door 1120, vehicle access device 1200, wheelchair securement system 1300, perception sensors 1030, and central monitoring 1040.

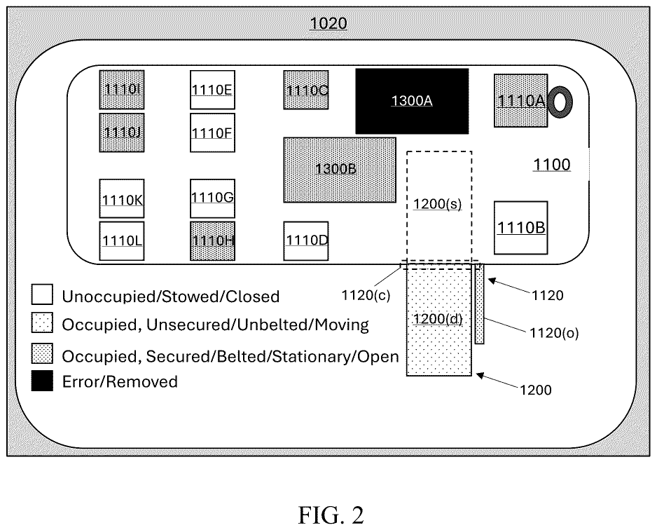

More particularly, the computing device 1010 may communicate and/or receive information to/from vehicle passengers, operators, or passersby through the user interface 1020, which may comprise multiple interfaces of any form and may be disposed on or remotely from the vehicle 1100. The user interface 1020 may provide for unidirectional communication between the computing device 1010 and a passenger (e.g., to the passenger or from the passenger) or bidirectional communication. Without limitation, the user interface 1020 may take form as one or more of: displays/screens; virtual reality or augmented reality headsets, glasses, or displays; touch pads or screens; a keyboard; buttons, switches, joysticks, or other similar input devices or controllers; a microphone, camera, or other perception sensors that can, for example, detect human gestures (hand, arm, eye, etc.); a sound generating device, such as a bell, annunciator or speaker; a light generating device, such as a light bulb, LED, or light/image projector; a haptic feedback device, such as a vibration mechanism; and personal computing devices, such as iPhones and iPads. In one embodiment, the system 1000 may be provided with: a user interface 1020 for (e.g., on or adjacent) any one or more of the vehicle seats 1110 (see, e.g., seats 1110A-L in FIG. 2); a user interface 1110 for any one or more of the vehicle access devices 1200 (see, e.g., vehicle access device 1200 in the deployed position 1200(d) and the stowed position 1200(s) in FIG. 2); a user interface 1110 for any one or more of the wheelchair securement systems 1300 (see, e.g., wheelchair securement systems 1300A-B); a user interface 1100 for the outside of the vehicle, including on or adjacent any one or more of the vehicle doors 1120 (see, e.g., vehicle door 1120 in the open condition 1120(o) and the closed position 1120(c) in FIG. 2). As desired, additional user interfaces 1100, including in the form of personal computing devices, including those located remote from the vehicle, may be connected to the system 1000. For instance, where a school bus has been equipped with a system described herein, a parent could confirm through an application on a personal computing device that their child was properly secured. Where multiple user interfaces 1100 are utilized, the displayed information, input options/buttons/controls, and/or output for each user interface 1100 may be identical or may be specifically tailored for the adjacent device or user.

The computing device 1010 may also transmit and/or receive information to/from the vehicle network 1130, which may be the vehicle CAN network or some other secondary or proprietary network in the vehicle. Any information available to the computing device 1010, such as the status and configuration of connected devices and instructions/commands and warnings/alerts for those connected devices, may be shared with the vehicle network 1130. Further, any information available to the vehicle network, such as ignition status, door status, transmission status, etc., may be shared with the computing device 1010. Notably, in some embodiments, any one or more of the “connected” devices, such as the user interface 1020, vehicle seats 1110, vehicle door 1120, vehicle access device 1200, wheelchair securement system 1300, perception sensors 1030, and central monitoring 1040, may communicate with the computing device 1010 as described herein indirectly through the vehicle network 1130 (as opposed to direct communication as suggested by FIG. 1).

The computing device may also transmit and/or receive information to/from central monitoring 1040, which may be a computing device or user interface at a dispatch center. Any information available to the computing device 1010, such as the status and configuration of connected devices and instructions/commands and warnings/alerts for those connected devices (e.g., any and all directional cues, instructional cues, status cues, troubleshooting cues, etc., including those described below), may be shared with central monitoring 1040. In turn, central monitoring 1040 may share any information available to it, including information concerning the location and characteristics/conditions of a passenger to be picked up, or information concerning the destination of a passenger. Individually or in cooperation with each other, the system 1000 and central monitoring 1040 may select or reserve vehicle seats 1110 and wheelchair securement systems 1300 for future passengers. In one embodiment, the system 1000 may prepare any one or more of the connected devices for the future passenger.

The computing device 1010 may receive input from a perception sensor 1030 that is configured to sense any aspect of the environment inside, outside, and/or around the vehicle 1100. Without limitation, the perception sensor 1030 may take form as one or more of a camera sensor, a LiDAR sensor, a ToF sensor, a RADAR sensor, a EmDAR sensor, a SONAR sensor, a SODAR sensor, a GNSS sensor, an accelerometer sensor, a gyroscope sensor, an IMU sensor, an infrared sensor, a laser rangefinder sensor, an ultrasonic sensor, an infrasonic sensor, and a microphone. In one embodiment, the computing device 1010 and perception sensor 1030, individually or in cooperation, could be configured to detect any one or more dynamic characteristic of a passenger, a passenger seated in a wheelchair, and/or a passerby, such as location (e.g., absolute location or location relative to other components or features of the vehicle), speed, velocity, acceleration, and direction of travel. In other embodiments, the perception sensor 1030 could be configured to detect any one or more physical characteristics of a passenger/passerby, such as standing, seated in a wheelchair, wheelchair type, wheelchair configuration, wheelchair model, whether the wheelchair seat is reclined, weight of passenger, weight of wheelchair, combined weight of passenger and wheelchair, whether passenger/wheelchair accessories, such as bags or other objects, are hanging from or attached to a wheelchair and backpacks, and where those bags or other objects are located on the passenger/wheelchair. The perception sensor 1030 could also be configured to detect if the passenger is moving in or falls out of the wheelchair. The perception sensor 1030 could also be configured to detect various characteristics of structures and devices in the vehicle 1100. For example, the perception sensor 1030 could detect various conditions or characteristics of the vehicle door 1120, vehicle seats 1110, wheelchair securement system 1300, and vehicle access device 1200, as described herein. The perception sensor 1030 could also detect various characteristics and conditions of the vehicle 1100, e.g., location, moving, stationary, turning, acceleration, velocity, crash detection/anticipation, inside temperature, outside temperature, door open/closed, window open/closed, etc.

The computing device 1010 may also receive input from vehicle seat 1110 sensors (including switches) that are configured to detect a condition or characteristic of the vehicle seat 1110, including but not limited to seat occupied/unoccupied, seat present/removed, seat not properly secured to the floor, seatbelt buckled/unbuckled, seatbelt not worn properly (incorrectly positioned on body).

The computing device 1010 may also receive input from vehicle door 1120 sensors that are configured to detect a condition or characteristic of the door 1120, including but not limited to door open/closed, window open/closed, door fault (e.g., door blocked, door operator overcurrent, etc.). Conventional sensors (including switches) known in the art may be used to detect these conditions/characteristics. For the avoidance of doubt, vehicle door 1120 may be a swing door, slide door, folding door, or other form of door, and may be powered or unpowered.

The computing device 1010 may also receive input from vehicle access device 1200 sensors that are configured to detect a condition or characteristic of the vehicle access device 1200, such as deployed/stowed, obstructed/clear, and fault. For avoidance of doubt, the vehicle 1100 may be provided with multiple vehicle access devices 1200, any of which may take form as any device that assists a person with limited mobility with vehicle ingress and egress, such as ramps, lifts, deployable steps, transfer seats, vehicle access seats, winches, etc. In the case of a ramp, the vehicle access device 1200 sensors may be configured to detect ramp deployed/stowed, ramp obstructed/clear, ramp fault, vehicle angle, ramp angle, ramp length, weight of passenger/wheelchair on ramp, location of passenger on ramp, passenger/wheelchair correctly/incorrectly positioned, passenger number or weight exceeded etc. In the case of a lift, the vehicle access device 1200 sensors may be configured to detect lift deployed/stowed/position/moving/stationary, lift obstructed/clear, lift fault, vehicle angle, lift platform angle, weight of passenger/wheelchair on platform, location of passenger on platform, passenger/wheelchair correctly/incorrectly positioned, passenger number or weight exceeded, speed of platform movement, position/status of barriers (e.g., side rails/barriers, platform inboard barrier, platform outboard barrier, and vehicle door opening barrier).

The computing device 1010 may also receive input from wheelchair securement system 1300 sensors that are configured to detect a condition or characteristic of the wheelchair securement system 1300, such as occupied/unoccupied, occupant restraint unbuckled/buckled, wheelchair securement secured/unsecured and/or deployed/stowed, the location of the passenger/wheelchair, passenger/wheelchair correctly/incorrectly positioned, passenger/wheelchair overweight, and fault (including failure to use or improper use of occupant restraint or wheelchair securement). In the case where the securement system 1300 includes a strap tie-down (e.g., a retractor), the sensor could detect any one or more of whether the strap is retracted or withdrawn, whether the hook is in a storage pocket, the length of strap that has been withdrawn, whether the strap or hook has been connected to the wheelchair, where on the wheelchair the strap has been connected, whether the strap/retractor is locked or unlocked, the strap angle from the anchor point to the wheelchair, the length of the strap from the anchor point to the wheelchair, the tension in the strap, whether the retractor is damaged or malfunctioning, whether the strap is dirty or damaged, and whether the hook is damaged. In the case where the securement system 1300 includes a moveable or non-movable bumper, the sensor could detect whether the bumper is contacting the wheelchair, the location of the contact area on the bumper and/or wheelchair, the contact force between the bumper and wheelchair, whether the bumper and/or the movement mechanism is damaged or malfunctioning. In the case where the securement system 1300 includes a wheelchair docking system, the sensor could detect any one or more of whether the wheelchair docking system has received the wheelchair, whether the docking system is locked, the height of the dock, the height of the wheelchair, whether the wheelchair docking system is damaged or malfunctioning. For the avoidance of doubt, a system 100 may comprise multiple wheelchair securement systems 1300, and each may take the same or different form, including but not limited to strap-type tiedowns, docking systems, bumpers and compression-based securements.

FIG. 2 is an exemplary user interface 1020 for the system 1000 of FIG. 1 of the type that may be provided for the vehicle operator. The user interface 1020 may include a screen that displays any information available to the computing device 1010, including but not limited to the status and configuration of the various accessibility and non-accessibility devices in the vehicle 1100, for example through characters, tables or images, renderings, or other representations of the vehicle 1000 and connected devices to convey such information. As shown, the user interface 1020 may include a top layout view of the vehicle 1100 with representations of the connected devices in their approximate locations. Each device may be color coded based on their status, as shown. For instance, the vehicle seats 1110A-L may be highlighted a different color depending upon whether the seat is unoccupied, occupied but unbuckled, occupied and buckled, removed from the vehicle, or has an error/fault condition. Similarly, the wheelchair securement systems 1300A-B could be highlighted a different color if the system is unoccupied and/or stowed, occupied and unsecured, occupied and secured properly, or in an error/fault condition. Similarly, the vehicle access device 1200 could be highlighted a different color depending upon whether the vehicle access device 1200 is stowed, unoccupied, occupied, stationary, moving, or in an error/fault condition. Similarly, the vehicle door 1120 could be highlighted a different color depending upon whether the door 1120 is open, stationary, moving, or closed. The visual representation of each device could also move or change on the user interface 1020 depending upon the condition of the device. For instance, the door 1120 could be shown in the door open position 1120(o) when open and in the door closed position 1120(c) when closed. Similarly, the vehicle access device 1200 could be shown in the deployed position 1200(d) when deployed and in the stowed position 1200(s) when stowed. As actual conditions of the devices change, the associated color and/or position of the device may change on the user interface 1020. The change in color or position on the user interface 1020 may be accompanied by other visual, auditory, or haptic cues for the vehicle operator, particularly if the change in condition is a safety-related condition that concerns the safety of the passengers. In alternative embodiments, the user interface 1020 shown in FIG. 2 may utilize augmented reality, e.g., by superimposing color-coding, highlights, or other computer-generated images, characters, or information on top of images/video captured from one or more cameras in/on the vehicle or on a user's personal computing device.

The computing device 1010 may reference various sensed parameters to determine whether a given wheelchair securement system 1300 is unoccupied or occupied, whether a wheelchair therein is secured or unsecured, and whether a passenger therein is belted or unbelted. In one embodiment, the computing device 1010 utilizes a perception sensor 1030, such as a camera, and machine learning technology and algorithms for this purpose. For instance, the computing device 1010 may conclude that the wheelchair securement system 1300 is occupied if the computing device 1010 recognizes the presence of a wheelchaired passenger in a wheelchair securement area of the wheelchair securement system 1300. The computing device 1010 may conclude that the wheelchair is secured the computing device 1010 recognizes the presence of all components of the wheelchair securement system 1300, e.g., in a four point tiedown system, all four tie-down belts. In some embodiments, the computing device 1010 may analyze the geometry of each tiedown belt and only conclude the wheelchair is secured if one or more required parameters are met, such as belt angle, belt length, correct placement of hooks on wheelchair, etc. The computing device 1010 may conclude that the occupant is belted if the computing device 1010 recognizes the presence of one or more of the occupant tongue belt, the occupant buckle belt, and occupant shoulder belt applied to the passenger's body. In some embodiments, the computing device 1010 may analyze the geometry of the occupant belt and only conclude that the occupant is belted if the occupant belt tongue is connected to the occupant belt buckle and/or if the various occupant belts are properly positioned on the passenger's body (e.g., lap belt across pelvis, low and snug across hips and/or upper thighs, and not across stomach; shoulder belt across the middle of chest and away from next, not placed behind back or under arm; and/or lap belt should not go over wheelchair armrests).

In other embodiments, the computing device 1010 may rely upon wheelchair securement system 1300 sensors to determine whether a given wheelchair securement system 1300 is unoccupied or occupied, whether a wheelchair therein is secured or unsecured and/or locked or unlocked, and whether a passenger therein is belted or unbelted. For instance, the computing device 1010 may utilize one or more weight sensors on, in, or under the floor in the wheelchair securement area to determine whether the wheelchair securement system 1300 is occupied or unoccupied. If the sensed weight is indicative of the presence of a wheelchaired passenger (e.g., the sensed weight is in a correct location and/or is within a certain predetermined range), the computing device 1010 may conclude that the wheelchair securement system 1300 is occupied.

To determine whether the wheelchair is secured or unsecured and/or locked or unlocked, the computing device 1010 may utilize one or more of a sensor that determines when a tiedown hook is disposed in a storage pocket (e.g., a proximity sensor configured to detect a magnet connected to the hook or the belt adjacent the hook), a sensor configured to detect the length of the withdrawn belt (e.g., a counter on a retractor spool or a counter on a wheel riding on the surface of the belt, in combination with a sensor detecting the rotation direction of the spool or wheel), a sensor configured to detect the angle of a withdrawn belt, and/or a sensor configured to detect a position of a a tiedown retractor locking mechanism. For instance, the computing device 1010 may determine that a given tiedown is unsecured anytime the tiedown hook is determined to be disposed in a storage pocket and is secured anytime the tiedown hook is determined to be absent from the storage pocket. In another embodiment, the computing device 1010 may determine that a given tiedown is unsecured anytime the length of the tiedown is below a certain predetermined threshold and secured anytime the length is above another predetermined threshold. In some embodiments, the length must be determined to be above that predetermined threshold for a predetermined period of time before the computing device 1010 concludes that the tiedown is secured. In some embodiments, the angle of the belt must be determined to satisfy a predetermined threshold, which may be a range of angles, before the computing device 1010 concludes that the tiedown is secured. In some embodiments, the computing device 1010 determines whether a tiedown retractor is locked or unlocked based on the position of the tiedown retractor locking mechanism.

To determine whether a passenger is secured with an occupant belt, the computing device 1010 may utilize one or more of a sensor that detects when the lap belt tongue is engaged with a lap belt buckle and/or a sensor that detects when a shoulder belt connector is connected to the lap belt.

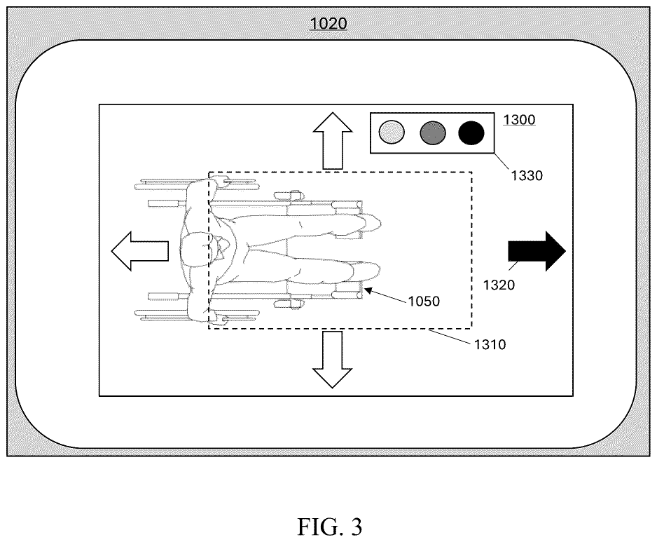

As discussed herein, the computing device 1010 may be configured to receive information indicative of the location of a wheelchair passenger in or around the vehicle, using perception sensors 1030 or other sensors associated with or imbedded in connected devices, such as the vehicle access device 1200 or wheelchair securement system 1300 (e.g., pressure sensors on the vehicle access device 1200 platform, wheelchair securement area floor, or wheelchair securement system 1300 platform). The computing device 1010 may be configured to convey that location information to the vehicle operator, attendant, or wheelchair passenger through one or more of the user interfaces 1020. For instance, as shown in FIG. 3, the computing device 1010 may be configured to display the location of the wheelchair passenger 1050 relative to the wheelchair securement system 1300 on a user interface 1020. In addition or in the alternative, various directional cues, such as forward, rearward, left, and right arrows 1320, that guide a wheelchair passenger 1050 into an acceptable/ideal/desired location 1310 for securement by the wheelchair securement system 1300 may be provided. In this case, the forward arrow has been illuminated to inform the vehicle operator, attendant, or passenger that the wheelchair needs to move forward. Additional or alternative directional cues may be provided, such as green lights, yellow lights, and/or red lights 1330, to indicate that the wheelchair should go, slow down as the wheelchair is nearing the desired location 1310, and stop when the wheelchair has arrived at the desired location 1310. In alternative embodiments, the user interface 1020 shown in FIG. 3 may utilize augmented reality, e.g., by superimposing directional cues, the desired position for the wheelchaired passenger, or other computer-generated images, characters, or information on top of images/video captured from one or more cameras in the vehicle or on a user's personal computing device. In other embodiments, similar directional cues, may also be provided by sound generating or haptic feedback devices. In the case of computer-generated verbal or written directional cues, the absolute (e.g., “5 inches”) or relative (e.g., “slightly”) distance the passenger must move in a certain direction may be conveyed and/or the speed at which the passenger should move (e.g., if close to desired position, “slowly”). In some implementations, the floor of the vehicle 1100 or any aspect of the wheelchair securement system 1300 may include light emitting devices that serve as the user interface 1020, e.g., light emitting devices adjacent a front edge, a left edge, a right edge, and a rear edge of the wheelchair securement system 1300 (or desired location 1310) that illuminate when the wheelchair needs to move forward, left, right, and rearward, respectively, or stop. In another example system including a four-point tiedown system (one at each corner of the wheelchair), each tiedown could be provided with a light emitting device (e.g., the two front tiedown lights could illuminate (solid color or blinking) to provide a directional cue in the forward direction, the two right side tiedown lights could illuminate to provide a directional cue in the right direction, the two front and right rear tiedown lights could illuminate to provide a directional cue in the forward-right direction). In other implementations, the floor of the vehicle 1100 or wheelchair securement system 1300 may be illuminated with any of the directional cues discussed herein using light (e.g., laser) projectors.

In some implementations, the desired location 1310 may be the same for all wheelchairs 1050. In other implementations, the desired location 1310 may be different depending upon an identity of the wheelchair 1050. The desired location 1310 for each wheelchair 1050 identity may be stored in the computing device 1010 memory or may be obtained from central monitoring 1040. The desired location 1310 for any wheelchair 1050 may be selected based on the passenger's preference, based on the wheelchair model or configuration, based on the presence and/or position of bags or other objects on the wheelchair 1050, etc. The computing device 1010, upon receiving information concerning the identity of the wheelchair 1050 being secured (or concerning characteristics of that wheelchair 1050), can direct the wheelchair 1050 into the desired location 1310 associated with such wheelchair 1050.

In some implementations, the computing device 1010 may be configured to provide similar directional cues to assist with ingress and egress using vehicle access device 1200. For example, in a case where the vehicle access device 1200 is a lift, the computing device 1010 may guide the wheelchair to a desired location on the lift platform in the same way described above for guiding the wheelchair into a desired location for the wheelchair securement system 1300. Additionally, a red “stop” light may be utilized to ensure the wheelchair passenger stays stationary while the lift is moving, and a green “go” light may be utilized when it is safe for the wheelchair passenger to move on or off the lift platform. In a case where the vehicle access device 1200 is ramp, the computing device 1010 may guide the wheelchair toward a center region of the ramp, and away from the safety side rails, during ingress and ingress. Additionally, a red “stop” light may be utilized while the ramp is moving between a stow position and the deployed position and a green “go” light may be utilized once the ramp is fully deployed and it is safe for the wheelchair to utilize the ramp. As before, sound-generating and haptic devices may be used in addition to or as an alternative to visible or illuminating devices.

At any point prior to or during wheelchair ingress, the computing device 1010 may receive information indicative of the individual (i.e., the weight of the wheelchair or the weight of the passenger) and/or combined weight of the wheelchaired passenger. For instance, the computing device 1010 may receive the weight information from central monitoring 1040. In another embodiment, the vehicle access device 1200 may be equipped to sense a combined weight of the wheelchair and passenger during ingress. Alternatively, the vehicle 1100 (e.g., floor, suspension, etc.) or the wheelchair securement system 1300 platform may be equipped to sense the combined weight. In one embodiment, the wheelchair securement system 1300 platform may be equipped with a weight sensor, for example, under the desired location 1310. The computing device 1010 may then compare the sensed/provided weight with one or more weight limits or prescribed weight range (minimum weight limit and/or maximum weight limit, individual and/or combined) for the wheelchair securement system 1300, alert an individual (the vehicle operator, attendant, or passenger) if the weight is acceptable or unacceptable, and/or activate/enable or deactivate/interlock the wheelchair securement system 1300. In one implementation, activating the wheelchair securement system 1300 may involve unlocking strap tiedown retractors so that the straps may be withdrawn from the retractors and secured to the wheelchair. In other implementations, activating the wheelchair securement system 1300 may additionally or alternatively involve providing instructions via the user interface 1020 to guide the individual through securement steps, as discussed hereinafter. In other implementations, activating the wheelchair securement system 1300 may additionally or alternatively involve prompting the individual to activate the wheelchair securement system, for example via a button on the dashboard. To the extent that the vehicle is equipped with multiple wheelchair securement systems 1300A, 1300B that have different weight limits, the computing device 1010 may then direct the individual to use the wheelchair securement system(s) 1300A, 1300B that is/are properly rated for the sensed combined weight of the passenger (e.g., by providing directional cues), activate/enable the wheelchair securement system 1300A, 1300B that should be used, deactivate/interlock the wheelchair securement system(s) 1300A, 1300B that should not be used, and/or otherwise indicate which wheelchair securement system(s) 1300A, 1300B should not be used.

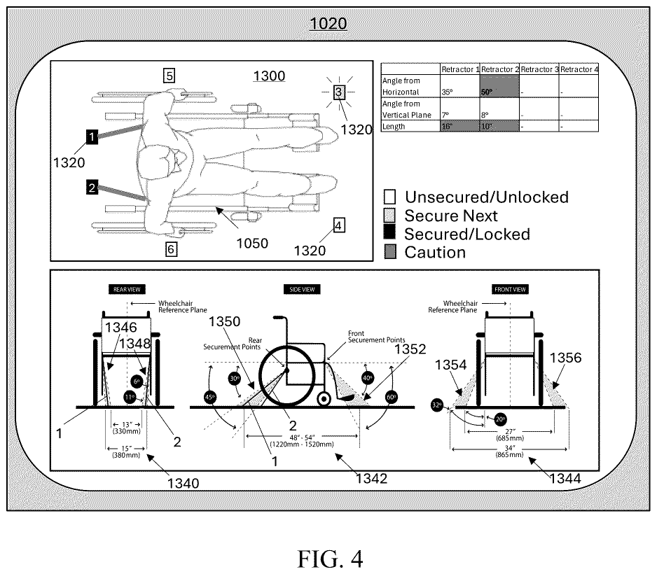

As discussed above, the computing device 1010 may be configured to provide a vehicle operator or attendant step-by-step guidance/instructions on use of the accessibility devices in the vehicle 1100, for instance the wheelchair securement system 1300. The computing device 1010 may be configured to convey that instructional information to the vehicle operator, attendant, or passenger through one or more of the user interfaces 1020. For instance, as shown in the top left corner and the bottom in FIG. 4, the computing device 1010 may be configured to display on a user interface 1020 instructional cues overlaid upon a representation of the wheelchaired passenger 1050 positioned in the wheelchair securement system 1300. Additionally or alternatively, as shown at the top left, top right, and bottom of FIG. 4, an indication of the status of the wheelchair securement system 1300 (e.g., any condition or characteristic of the wheelchair securement system 1300, including those listed above) may be overlaid on representations of the wheelchair securement system 1300 or displayed in tabular form, whereby an individual can receive feedback on compliance and non-compliance with the provided guidance and instructions.

With reference to the top left corner of FIG. 4, the user interface 1020 displays a top view of a wheelchaired passenger 1050 in the process of being secured in a four-point wheelchair tie-down and occupant securement system 1300 comprising four tie-down retractors 1320 numbered 1, 2, 3, and 4, a shoulder/lap belt retractor numbered 5, and a lap belt buckle numbered 6. Status cues may be overlaid on components of the wheelchair securement system 1300 to reflect their status, for instance, whether they are properly utilized or not (e.g., unsecured, unlocked, secured, locked, etc.). Instructional cues may also be overlaid on components in succession in a predetermined or adaptive order (e.g., based on wheelchair identity or type, passenger identity or characteristics, etc.) to reflect each step of securement. Once the computing system 1010 receives confirmation that an instructional cue has been followed, either by operator confirmation through the user interface 1020 or feedback from a sensor, the instructional cue may be cleared, status cues may be updated, added, or removed, and the next instructional cue in the series of securement steps may be displayed. Troubleshooting cues may also be overlaid on components that have been installed improperly or out of specification.

More particularly, in one embodiment, wheelchair securement components could be highlighted white to reflect an unsecured and/or unlocked status, black to reflect a secured and/or locked status, and light gray to reflect that the wheelchair component is the next component that should be secured by the operator. Components that are secured out of specification may be highlighted dark gray. As seen in FIG. 4, wheelchair tie-down retractors 1320 numbered 1 and 2 are highlighted black and belts are shown in dark gray extending from retractors 1 and 2 to the wheelchair 1050 to reflect that tie down retractors 1 and 2 are secured to the wheelchair 1050 and locked, but the belts are secured out of specification. Once the belt placement is corrected, the status cue may change from a dark gray belt to a black belt. Additionally, tie-down retractor 4, shoulder/lap belt retractor 5, and lap belt buckle 6 are highlighted white and associated belts are not shown to reflect that they are both unsecured and unlocked. Tie-down retractor 1320 numbered 3 is highlighted light gray and is blinking to provide an instructional cue for the installer to secure retractor numbered 3 to the wheelchair next. Once the operator properly secures tie-down retractor 3 to the wheelchair, the status of retractor 1320 number 3 may be highlighted black with a black belt extending between the retractor 1320 number 3 and the wheelchair 1050 (to reflect that retractor 1320 number 3 and its belt are secured and locked), and retractor 1320 number 4 may change color from white to blinking light gray (as an instructional cue reflecting the next step in securing the wheelchaired passenger 1050). In some embodiments, the computing system 1010 may be configured to not display the next instructional cue until any specific or all troubleshooting cues are addressed. For instance, in the case of FIG. 4, retractor 1320 numbered 3 would not be highlighted gray or blinking until the out of specification belts for retractors 1320 number 1 and 2 are corrected.

With reference to the top right corner of FIG. 4, status cues for one or more components of the wheelchair securement system 1300 may be provided in numerical format in a table. The information provided in the table may be used by an individual to diagnose improperly applied components of the wheelchair securement system 1300 (e.g., those components highlighted in dark gray). In this case, geometric and dimensional parameters of each tie-down retractor 1320 numbered 1, 2, 3, and 4, are displayed, such as angle from horizontal plane, angle from vertical plane, and length. Other data may be provided, such as tension in the belts, distance between two rear retractors 1320 numbered 1, 2, distance between two front retractors 1320 numbered 3, 4, distance from rear retractors 1320 number 1 and/or 2 to front retractors 1320 numbered 3 and/or 4, distance between a given retractor 1320 numbered 1, 2, 3, and/or 4 and longitudinal and/or lateral centerline for the wheelchair securement system 1300, etc. Troubleshooting cues may also be provided to identify those characteristics that are out of specification. In this case, out of specification parameters are highlighted dark gray. In particular, the belt for tie-down retractor 2 extends at 50° from horizontal, outside of the permissible/predetermined range of 30-45°. In addition, the differential for belt lengths for retractors 1320 numbered 1 and 2 exceeds a predetermined acceptable differential suggesting that the wheelchair 1050 may be facing (angled) too far to the right and not straight forward as intended, or at least one of the retractors 1320 numbered 1, 2 has been mounted in an improper location.

With reference to the bottom of FIG. 4, status, instructional, and troubleshooting cues may be overlaid on additional views of the wheelchaired passenger 1050 being secured. In these views, geometric cues may be provided to reflect permissible securement parameters, such as instructional cues 1340 reflecting the permissible range of locations/distances between the floor anchor points of the rear tie-down retractors 1 and 2, instructional cues 1342 reflecting the permissible range of locations/distances between the floor anchor points for the rear retractors 1320 numbered 1 and 2 and the front retractors 1320 numbered 3 and 4, instructional cues 1340 reflecting the permissible range of locations/distances between the floor anchor points of the front retractors 1320 numbered 3 and 4, and instructional cues 1346, 1348, 1350, 1352, 1354, and 1356 reflecting the ranges of permissible belt angles from horizontal and/or vertical planes. Instructional cues 1340, 1342, 1344, 1346, 1348, 1350, 1352, 1354, and 1356 may reflect the permissible floor mounting locations for each retractor and/or actual permissible dimensions/angles. Representations of the retractor belts may be overlaid in each view, which allows a vehicle operator to diagnose improperly applied components of the wheelchair securement system 1300. In this case, it can be seen that: the floor anchor points for retractors 1320 numbered 1 and 2 are spaced properly from each other and with respect to the longitudinal centerline of the wheelchair 1050/wheelchair securement system 1300, the belt for retractor 1320 numbered 1 falls within the zone 1346 (reflecting permissible belt angle with respect to a vertical plane) and zone 1350 (reflecting permissible belt angle with respect to a horizontal plane), and the belt for retractor 1320 numbered 2 falls within the zone 1348 (reflecting permissible belt angle with respect to a vertical plane) but falls outside zone 1350 (reflecting permissible belt angle with respect to a horizontal plane).

With respect to the status and troubleshooting cues provided in the embodiment shown in FIG. 4, a vehicle operator will know that the floor anchor point for retractor 1320 numbered 2 should be moved rearward such that it falls within zone 1350. Such a corrective action not only will reduce the belt angle for retractor 2 from the out-of-specification 50° but will also increase its length, whereby the length differential between retractors 1 and 2 will be reduced. In that regard, the troubleshooting cues (dark gray highlight in this instance) may be removed from the user interface 1020.

Many wheelchairs, particularly those compliant with WC-19, include designated connection points configured to receive tie-down securement hooks. In some embodiments, the computing device 1010 may be configured to receive input indicative of the location of those designated connection points or work in cooperation with perception sensors 1030 to identify those connection points. Utilizing such input or identification, the computing device 1010 may provide adaptive instructional cues that point out the location of those unique connection points for the individual securing the wheelchair. In some embodiments, augmented reality may be utilized, including by highlighting where securements should be connected on images generated from an individual's personal computing device camera. In some embodiments, the computing device 1010 may also be configured to verify correct placement of those securements based on the personal computing device camera image and, if incorrectly placed, the computing device may provide troubleshooting cues and additional instructions to ensure correct placement.

After each securement (e.g., tiedown retractors and/or occupant belts) is secured and/or locked, or after all securements are secured and/or locked, the computing device 1010 may automatically capture one or more images (photographs or videos) of the securements and/or wheelchaired passenger 1050 from cameras located in the vehicle 1100. In other embodiments, the instructional sequence for securement may require the individual securing the wheelchaired passenger to take and upload one or more photographs or videos from the individual's personal computing device camera or other camera. The images may then be stored permanently, indefinitely, or for a predetermined period of time in the computing device 1010 memory (or sent the to central monitoring 1040 for storage) for later training or investigation purposes. In some embodiments, the computing device 1010 may be configured to automatically capture one or more images in the event an adverse condition is detected (e.g., securements are or become out of specification, securements become unlocked or unsecured, unexpected movement of a wheelchaired passenger or movement that exceeds a predetermined threshold, the vehicle experiences an acceleration that exceeds a predetermined threshold, etc.), at any point in time, including before the wheelchaired passenger enters the vehicle, as the wheelchaired passenger enters the vehicle and/or wheelchair securement system or area, during the process of securing or disengaging the wheelchair or after such process is completed, and during or after transit.

In some embodiments, the computing device 1010 may be configured to interlock the vehicle 1100 (e.g., prevent release of parking brake, prevent use of the transmission, prevent ignition, etc.) or the vehicle access device 1200 (e.g., preventing stowage of a ramp or lift platform) until the computing system 1010 can confirm that all components of the wheelchair securement system 1300 are properly secured and locked (e.g., within specification).

In some instances, a passenger may have personal preferences regarding the nonuse or non-standard, out-of-specification use of the wheelchair securement system 1300 or certain securements, such as an occupant belt. In other instances, a unique wheelchair configuration may prevent the use or standard, in-specification use of the wheelchair securement system 1300 or certain securements. In such instances, the computing device 1010 may provide an option (e.g., button) on the user interface 1020 for an individual to bypass or clear an instructional or troubleshooting cue. In such cases, a warning of associated risks of injury or other consequences could be provided that must be acknowledged by the individual before a troubleshooting cue, if present, and/or an interlock, if applied, is cleared or released. The acknowledgement may include a waiver of liability for such consequences. The acknowledgement received by the computing device 1010 may be in the form of button press or digital signature on the user interface 1020, and may require the individual to provide an indication of their identity, such as an image of the individual's face or identification card. Additionally, the computing device 1010 may prompt the individual to provide an image reflecting the non-use or non-standard, out-of-specification use of the wheelchair securement system or may automatically capture such image in response to receiving the aforementioned acknowledgement. Any acknowledgements and/or images may be stored in the computing device 1010 memory (or sent the to central monitoring 1040 for storage) for later training or investigation purposes permanently, indefinitely, or for a predetermined period of time.

For the avoidance of doubt, it is contemplated that the computing device 1010 may be configured to provide step-by-step guidance/instructions for any type of wheelchair securement system 1300. Furthermore, it is contemplated that the various cues described above can take any form, including grayscale or colored highlights, characters/text, images, lights (blinking or steady), etc. In alternative embodiments, the user interface 1020 shown in FIG. 4 may utilize augmented reality, e.g., by superimposing status, instructional, and troubleshooting cues, or other computer-generated images, characters, or information on top of images/video captured from one or more cameras in the vehicle or on a user's personal computing device. In other embodiments, similar directional cues may also be provided by sound generating or haptic feedback devices. In some implementations, the floor of the vehicle 1100 or any aspect of the wheelchair securement system 1300 may include light emitting devices that serve as the user interface 1020, e.g., light emitting devices on each component of the wheelchair securement system 1300 (e.g., each retractor 1320 and/or occupant belt tongue, buckle, and/or shoulder belt) that illuminate with instructional, status, and/or troubleshooting cues. For example, each tiedown retractor 1320 could be provided with a color-changing LED lamp. The LED lamp may blink yellow to provide an instructional cue that the associated belt should be secured to the wheelchair. If the individual secures the associated belt to the wheelchair within specification (e.g., correct angle, length, tension, location on wheelchair, etc.), the LED lamp may then be illuminated solid green. If the associated belt is secured to the wheelchair out of specification, the LED lamp may then be illuminated red. To assist in troubleshooting why the associated belt is out of specification, the LED lamp may be illuminated in other color (e.g., blue to reflect an incorrect angle, brown to reflect insufficient tension, etc.) or configured to blink with a coded pattern (two blinks followed by a short pause reflects an incorrect angle, three blinks followed by a short pause reflects insufficient tension, etc.). In other implementations, the floor of the vehicle 1100 or the components of wheelchair securement system 1300 may be illuminated with any of the cues discussed herein using light (e.g., laser) projectors.

Although the foregoing discussion only describes exemplary instructional, status, and troubleshooting cues that may be provided during a securement sequence for securing a wheelchaired passenger in a wheelchair securement system, it is contemplated that similar instructional, status, and troubleshooting cues may be provided in a disengagement sequence for releasing the wheelchaired passenger from the wheelchair securement system.

The apparatus, methods, and systems described herein provide real-time feedback and guidance for enhancing the securement experience for wheelchaired passengers during transit in a vehicle. Any of the features and functions described herein may be used individually or in combination.

For instance, in a first securement scenario, a system may be provided to guide an individual through the steps for securing a wheelchaired passenger in a vehicle. The system includes features for determining when the wheelchaired passenger is moved into a securement area, which may comprise a platform of a wheelchair securement system, such as the Q'Straint ONE system. In one embodiment, the system may include one or more weight sensors disposed underneath the platform that detect the weight of the wheelchaired passenger (the weight of the platform may be zeroed out, or the weight of the platform may be included within the predetermined threshold). If the detected weight falls outside of the predetermined threshold (which may be a minimum weight, a maximum weight, or a permissible range of weights), a troubleshooting cue may be provided to the individual via a user interface to warn that the weight is out of range or other error exists (e.g., the wheelchaired passenger's attendant or vehicle operator is standing on platform). If the detected weight satisfies the predetermined threshold, a status cue may be provided via a user interface to inform the individual that a wheelchaired passenger is present on the platform, the wheelchair securement system may be automatically activated (e.g., tiedown retractors and/or occupant belt retractors unlocked, and/or instructional cues for securing wheelchaired passenger provided via user interface), and/or the user interface will prompt the individual to activate the wheelchair securement system, for example by pushing a button. Regardless of how the wheelchair securement system is activated, instructional cues will be provided to guide the individual through the steps of securement. In one embodiment, the operated is guided via lighting on the tiedown retractors: a first retractor will light up and individual secures first retractor, after feedback is received indicating that the first retractor is secured, the second retractor will light up, and so on..

In a second securement scenario, real-time feedback from sensors associated with the wheelchair securement system may be provided to an individual, such as the vehicle operator. Any parameter of the wheelchair securement system, including those described herein, may be displayed in real-time for the individual, such as strap stored/deployed, strap angle, strap tension, strap length, tiedown secured, retractor unlocked/locked, occupant belt unbuckled buckled, etc. For instance, a sensor may be provided that provides positive confirmation of the position of a locking member of a tiedown retractor. The position of the locking member may be displayed on a user interface, for instance on a vehicle driver's dashboard, to provide real-time information of the locked/unlocked status of a tiedown retractor during transit. In another embodiment, a sensor may be provided that provides positive confirmation of the position of a tiedown retractor strap of an occupant belt, including whether the associated hook, tongue, or buckle are disposed in a storage pocket. Real-time information regarding the position of the strap or belt may be provided to the user interface, such as the driver's dashboard. In some embodiments, when positive confirmation of a stored position is received, the system may recalibrate any one or more of the sensor associated with the securement, including any strap or belt length sensors. Parameter feedback and calibration may be independent for each securement in a wheelchair securement system. In some embodiments, the system may continuously monitor and analyze any or all measured parameters of a wheelchair securement system to ensure that the parameters fall within safe predetermined thresholds.

In a third securement scenario, the system may be configured to detect and analyze length and/or angle feedback regarding tiedown securements in a wheelchair to identify possibly unsafe securement conditions. For instance, a sensor may be provided to detect the length of the strap pulled out of a tiedown retractor (or an occupant belt retractor). If the detected length falls out of a predetermined threshold (which may be a minimum length, a maximum length, or permissible range of lengths), a troubleshooting cue may be provided to the individual via a user interface to warn that the length is out of range or other error exists. Where a system comprises a plurality of tiedown securements, differences in webbing lengths for a given pair of tiedown securements (e.g., difference between two rear tiedown securements or difference between one front tiedown securement and one rear tiedown securement) may be determined and compared to a predetermined differential threshold (which could be a minimum, maximum, or permissible range). If the detected difference falls out of the predetermined differential threshold, a troubleshooting cue may be provided to the individual via a user interface to warn the individual of a potentially adverse securement condition (e.g., wheelchaired passenger off center in the securement area, tiedown secured to incorrect location on wheelchaired passenger, floor anchor point incorrect, etc.). In some cases, a sensor may be provided to detect the angle of the strap pulled out of a tiedown retractor (or an occupant belt retractor). If the detected angle falls outside of a predetermined threshold (which may be a minimum angle, a maximum angle, or a permissible range of angles), a troubleshooting cue may be provided to the individual via a user interface to warn that the angle is out of range or other error exists. Logic for interlocks may be based on feedback from the length and/or angle sensors. For instance, a tiedown retractor may be prevented from locking until the detected length of the strap satisfies the predetermined threshold, until any or all detected differences in lengths satisfies the predetermined differential thresholds, and/or until the detected angle of the strap satisfies the predetermined threshold. Status cues relating to use or occupancy of a wheelchair securement system may also be based on feedback from the length and/or angle sensors. For instance, the wheelchair securement system may be determined to be occupied or in use if the length and/or angle and/or variance in length of one or more of the tiedown retractor straps satisfies the predetermined thresholds for at least a predetermined period of time. Additional or alternative criteria may be utilized to determine occupancy, including other sensed parameters of the wheelchair securement system falling within specification/predetermined thresholds.

In a fourth securement scenario, the system may be configured to determine abnormalities in the straps and/or belts or in the environment that may compromise optimal performance of the wheelchair securement system, to prompt the system to provide an alert on the user interface, and/or to deactivate the wheelchair securement system until proper checks are performed or the abnormalities are cured. In one embodiment, a wheelchair securement system may have components that will not perform to specification in high and/or low temperature environments. In such case, a temperature sensor detecting the temperature of the specific component, the interior of the vehicle, and/or the exterior of the vehicle may be provided. In the event that the detected temperature fails to satisfy a predetermined temperature threshold, a troubleshooting cue may be generated by a user interface and/or the wheelchair securement system may be deactivated/interlocked. In another embodiment, the stiffness (or other parameter indicative of stiffness) of a strap or belt may monitored (for example, using a strain gauge) to identify changes in stiffness that may occur if the strap or belt is overloaded, for example during a vehicle accident. It is contemplated that other characteristics indicative of an overloading condition may be monitored. In the event that the detected characteristic exceeds a predetermined threshold, a troubleshooting cue may be generated by a user interface and/or the wheelchair securement system may be deactivated/interlocked. In another embodiment, the acceleration of the vehicle and/or the wheelchaired passenger may be monitored to identify adverse conditions of the vehicle (accident, heavy braking, etc.) or wheelchaired passenger (tip over). The system may receive acceleration information or other crash or pre-crash data from the vehicle through, for example, the CAN bus. In the event that the detected acceleration (or difference in acceleration between the vehicle and wheelchaired passenger) fail to satisfy a predetermined threshold, or if the system receives other input suggestive of a vehicular accident, a troubleshooting cue may be generated by a user interface and/or the wheelchair securement system may be deactivated/interlocked. In such case, the wheelchair securement system to be taken out of service for inspection and/or quarantining. In yet another embodiment, slack in a tiedown strap or occupant belt may be detected by a tension sensor. In the event that the detected tension fails to satisfy a predetermined tension threshold, a trouble shooting cue may be generated by a user interface, a motor associated with the retractor may be engaged to draw out the slack, and/or the wheelchair securement system may be deactivated/interlocked.

In a fifth securement scenario, the system may be configured to determine occupancy of a wheelchair securement system based on the status of an occupant belt tongue and buckle and/or a length of the occupant belt. For instance, a sensor may be provided that detects the position of a buckle latch when it engages a tongue and/or a sensor inside or outside of the buckle that senses the presence of the tongue or when the tongue is in close proximity to the buckle. If the sensor output is indicative or suggestive of the tongue engaging the buckle, the system may determine that the wheelchair securement system is occupied and corresponding status cues may be provided on a user interface. In another embodiment, the wheelchair securement system may be determined to be occupied or in use if the length of the occupant belts satisfies a predetermined threshold for at least a predetermined period of time. In yet other embodiments, multiple criteria or thresholds must be met before the system determines that the system is occupied (e.g., to confirm that the occupant belt is not positioned behind a passenger's back or simply connected together in the absence of a wheelchaired passenger). For instance, the system may require not only for the tongue and buckle to be engaged, but also for the occupant belt to be withdrawn at least a predetermined length and/or may require a detected weight to satisfy a predetermined threshold.

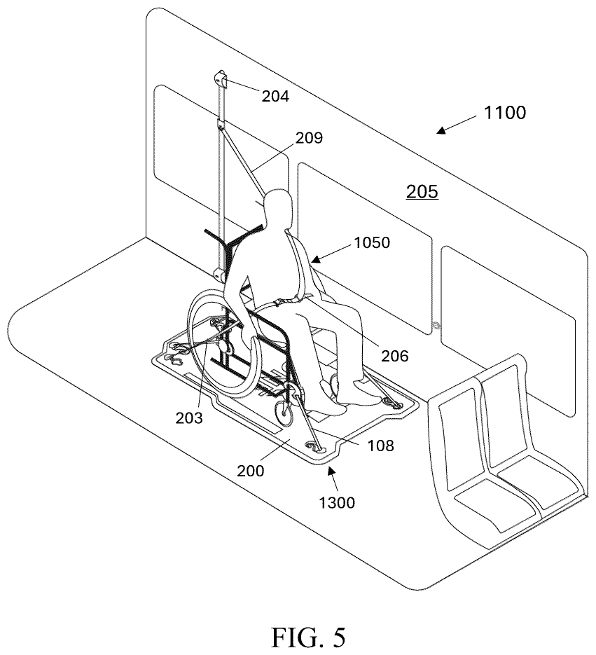

FIG. 5 is an exemplary wheelchair tie-down and occupant restraint system (WTORS) 1300 shown securing a wheelchair passenger 1050 within a vehicle 1100. This WTORS 1300 comprises a floor-mounted housing 200 which integrates four tie-down retractor units (not shown), a lap belt retractor (not shown), and a buckle belt 203. Additionally, a shoulder belt retractor 204 is mounted to a wall 205 of the vehicle 1100. Four tie-down straps 108 extend from their respective tie-down retractor units (not shown) to the wheelchair 1050, providing securement for the wheelchair 1050. For passenger restraint, a tongue belt 206 extends from the lap belt retractor (not shown) and, in combination with the buckle belt 203, which is secured to the floor-mounted housing 200 via a pin connector (not shown), forms a lap belt secured around the wheelchair passenger's 1050 midsection. A shoulder belt 209 extends from the vehicle wall-mounted shoulder belt retractor 204, passes around the passenger's 1050 shoulder and connects to the tongue belt 206 via a pin connector (not shown). Further details regarding such wheelchair securement systems and their components can be found in related disclosures, U.S. Patent Publ. Nos. 2023/0048271 and 2024/0173180. To provide a detailed understanding of the components that comprise the WTORS 1300, particularly the tie-down retractor units, attention is now directed to exemplary embodiments of such units.

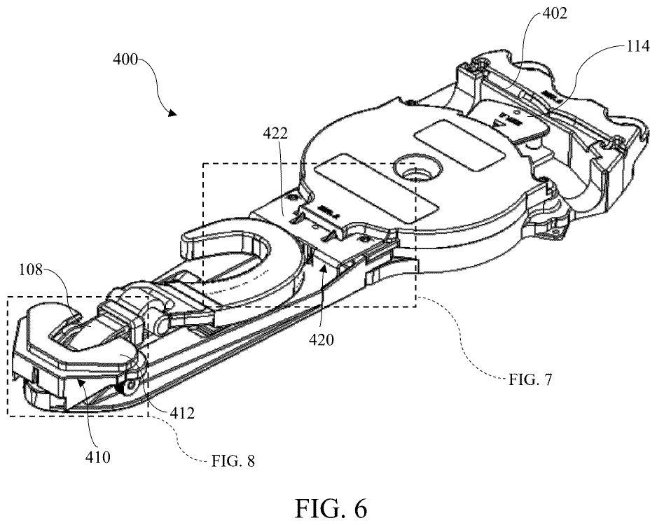

FIGS. 6-8 illustrate an improved retractor module 400, which serves as an example of a tie-down retractor unit that can be integrated within the floor-mounted housing 200 of FIG. 2. The lap belt retractor may have a similar construction, except it may have a tongue or a buckle at the end of the strap 108 instead of the hook. The retractor module 400 incorporates many components and functions similarly to known retractor modules disclosed in U.S. Patent Publ. Nos. 2023/0048271 and 2024/0173180. However, the retractor module 400 is enhanced to include various sensors for monitoring its operational status. These sensors may include a lock sensor 402, a strap deployment sensor assembly 420, and a hook position sensor assembly 410.

The lock sensor 402 is configured to determine if the internal locking mechanism, which prevents the strap from being withdrawn, is engaged or disengaged. In the depicted embodiment, the lock sensor 402 is positioned to detect the position of a locking lever 114, which may be moved between locked and unlocked positions using an actuator as described in the related publications. The lock sensor 402 may be a photoelectronic sensor, ultrasonic sensor, a ToF sensor, a magnet sensor wherein the locking lever 114 (or other component of the retractor locking mechanism) may have one or more magnets coupled to it or be made of a magnetic material detectable by a magnet sensor, or any other known types of sensors for determining the presence of an object. The sensor 402 may be positioned to determine either if the locking mechanism is in the locked position or if the locking mechanism is in the unlocked position. The sensor 402 may alternatively be coupled to or configured to read the position of the linear actuator.

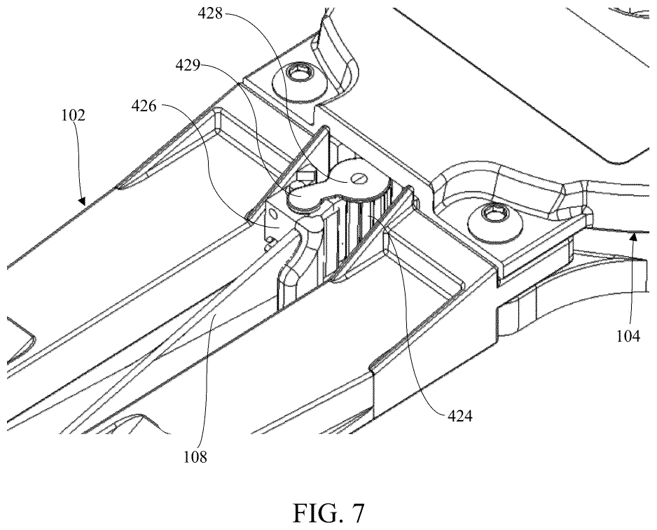

The strap deployment sensor assembly 420 is shown in detail in FIG. 7 where the sensor cover and hook are hidden to provide a more clear view of the assembly. The strap deployment sensor assembly 420 may include a pulley 424 configured to engage with the strap 108. The pulley 424 may be grooved, knurled, toothed, or any other texture to create friction between the pulley 424 and the strap 108 such that when the strap 108 is moving in either direction, it induces rotation of the pulley 424. A pulley sensor 426 may be positioned adjacent to the pulley 424 to detect rotation of the pulley 424 and measure the extent of the rotation or count the number of rotations. The pulley sensor 426 may be an encoder, a ToF sensor, a rotary position sensor, a magnet sensor wherein the pulley has one or more magnets coupled to it, or any other known method of measuring rotation. This sensor and/or an associated controller may then be configured based on the size of the pulley to convert to length of strap that is deployed.

A clutch 428 may be displaced above or below the pulley 424. Friction between the pulley 424 and the clutch 428 may induce rotation of the clutch 428 in the same direction as the pulley 424. A projection 429 may extend outwards from clutch 428. The projection 429 may be configured to trigger a pulley rotation direction sensor (not shown). When the pulley 424 rotates in a first direction, friction will cause the clutch 428 to rotate in the first direction and the projection 429 may travel to a first side. When the projection 429 reaches the first side, it may trigger a pulley rotation direction sensor. A stop may be provided prevent further rotation of the projection 429 and clutch 428 to keep the projection 429 engaged to trigger the pulley rotation direction sensor. The material of the clutch 428 may be optimized to minimize friction to allow pulley 424 rotation without rotating the clutch 428 and prevent wear of the clutch 428. When the pulley 424 rotates in a second direction, friction will cause the clutch 428 to rotate in the second direction and the projection 429 may travel to a second side. When the projection 429 reaches the second side, it may trigger the pulley rotation direction sensor. A stop may be provided prevent further rotation of the projection 429 and clutch 428 to keep the projection 429 engaged to trigger the pulley rotation direction sensor. The pulley rotation direction sensor may be integrated with the pulley sensor 426. The combination of the pulley rotation direction sensor with the pulley sensor 426 may promote accurate directional computations of strap deployment. For example, the system could be calibrated such that when the pulley 424 rotates in the first direction, the pulley rotation direction sensor may be calibrated to register that as a positive strap deployment value. Then, when the pulley 424 rotates in the second direction, the pulley rotation direction sensor may be calibrated to register that as a negative strap deployment value. This promotes accurate calculation of the strap deployment and ensures when the hook is returned to storage the strap deployment is reading as a zero value. In alternative embodiments, the strap deployment sensor assembly may be zeroed out whenever the hook position sensor assembly 410 detects that the hook is in the home, or stowed, position. The pulley rotation direction sensor may be a photoelectronic sensor, ultrasonic sensor, a ToF sensor, a magnet sensor wherein the projection 429 has one or more magnets coupled to it, or any other known method of measuring presence of an object.

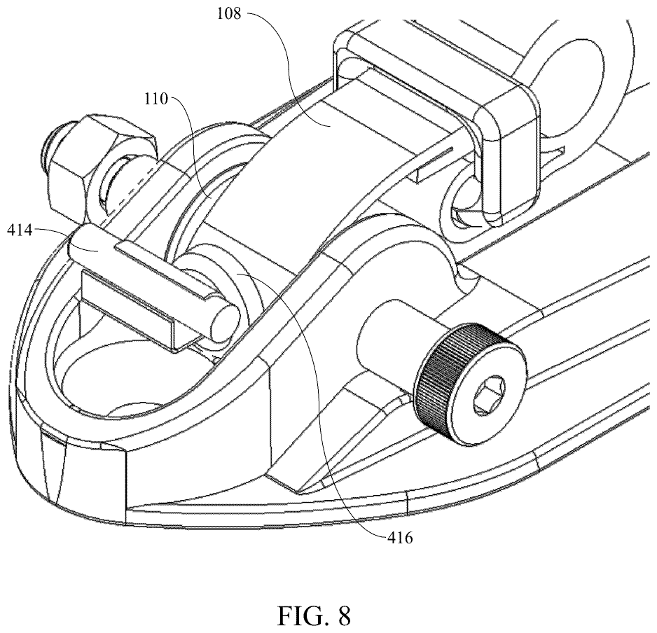

With reference now to FIG. 8, the hook position sensor assembly 410 may comprise a hook position sensor 414 that detects whether the hook is in the home/stow position seen in FIG. 6, as opposed to the secured position shown in FIG. 5. In the illustrated embodiment, the hook sensor 414 is a magnet sensor wherein the strap 108 includes a magnet 416 coupled to it. In other embodiments, the hook position sensor 414 may be a photoelectronic sensor, ultrasonic sensor, a ToF sensor, a weight sensor, or any other known types of sensors for determining the presence of an object. In a WTORS with a nesting location for the hook 112 to stow in (see, e.g., FIG. 5), the sensor may be positioned in said nesting location.

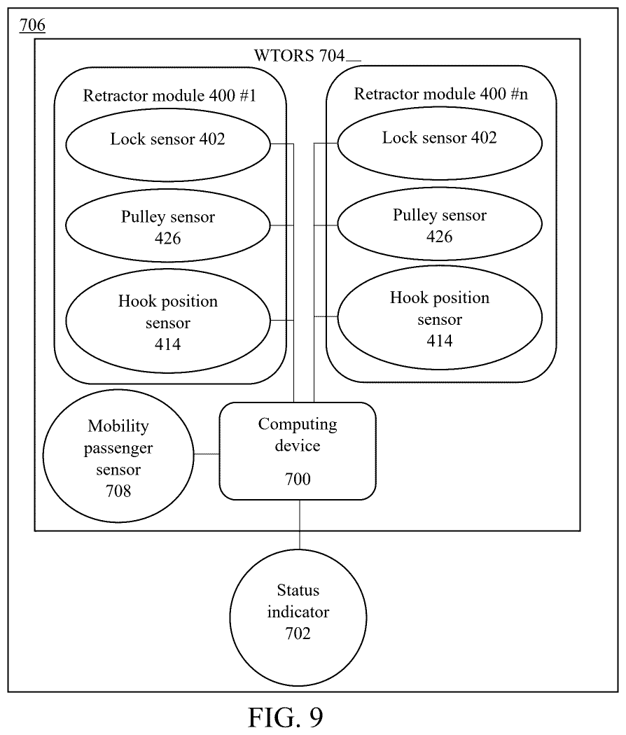

FIG. 9 details a network 706 in which a WTORS 704 includes anywhere from 1 to n retractor modules 400. The WTORS 704 may also include a computing device 700. In other embodiments, the computing device 700 may be external of the WTORS 704 or may be programmed into the vehicle. Alternatively, each retractor module 400 may have its own computing device 700. The WTORS may include a mobility passenger sensor 708 to determine the presence of a mobility passenger. The mobility passenger sensor 708 may be a weight sensor, photoelectronic sensor, ToF sensor, ultrasonic sensor, camera, or any other known method of sensing the presence of an object. Each retractor module 400 may have a lock sensor 402, pulley sensor 426, and/or hook position sensor 414 that may be electrically coupled to the computing device 700. The computing device 700 may be programmed to receive signals from each of the sensors and verify the retractor module 400 is properly applied to a wheelchair, or properly stowed when not in use. The computing module 700 may accomplish this by verifying the hook position sensor 414 indicates the hook is deployed, verifying the pulley sensor 426 measured an acceptable distance of strap 108 deployment, and verifying the lock sensor 402 indicates the linear actuator or locking mechanism is in the locked position. The computing device 700 may further be electrically coupled to a status indicator 702. The status indicator 702 may be a color-changing light or a screen configured to display a status text. The status indicator 702 may be positioned on or adjacent to the WTORS 704 or retractor module 400, or may be integrated into the vehicle's electrical system to display a status on a dashboard screen of the vehicle. Alternatively, the status indicator 702 may be coupled to the vehicle in a manner to lock out the driving controls when the computing device 700 determines an unsafe driving condition.

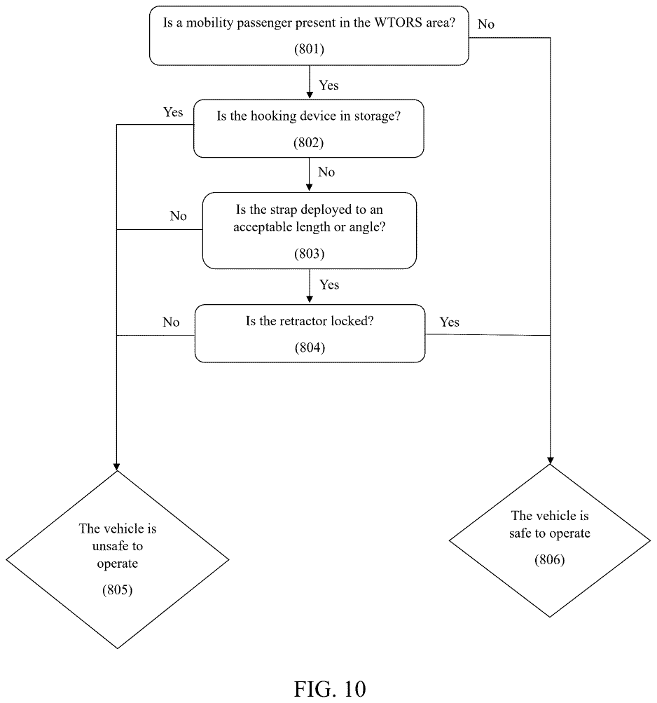

FIG. 10 illustrates a flowchart of example logic that the computing device 700 may be programmed to execute to determine if a retractor module 400 is being used properly. First, in Step 802, a mobility passenger sensor 708 may be used to determine the presence of a mobility passenger in the WTORS 704 area. If no mobility passenger is present, the vehicle is safe to operate as in Step 806. If a mobility passenger is present, the computing device 700 then moves onto Step 802 to determine if a hook of a retractor module 400 is in the storage position determined by a hook position sensor 414. If it is in the storage position, the vehicle is not safe to operate as in Step 805. If the hook 112 is not in the storage position, the computing device 700 will move to Step 803 to determine if the strap 108 has been deployed to an acceptable length as determined by a pulley sensor 426. If the strap 108 has not been deployed or been deployed to a length outside the acceptable range (too low or too high), the vehicle is not safe to operate as in Step 805. If the strap 108 is deployed to an acceptable length, the computing device 700 will move onto Step 804. Step 804 determines if the retractor module 400 is locked, ascertained by the lock sensor 402. If the retractor module 400 is locked, the vehicle is safe to operate as in Step 806 and if it is not locked, the vehicle is unsafe to operate as in Step 805. If the computing device 700 is coupled to a WTORS containing more than one retractor module 400, the computing device 700 may execute this logic for each of the retractor modules 400 in the system. For the avoidance of doubt, these steps may be executed in any order.

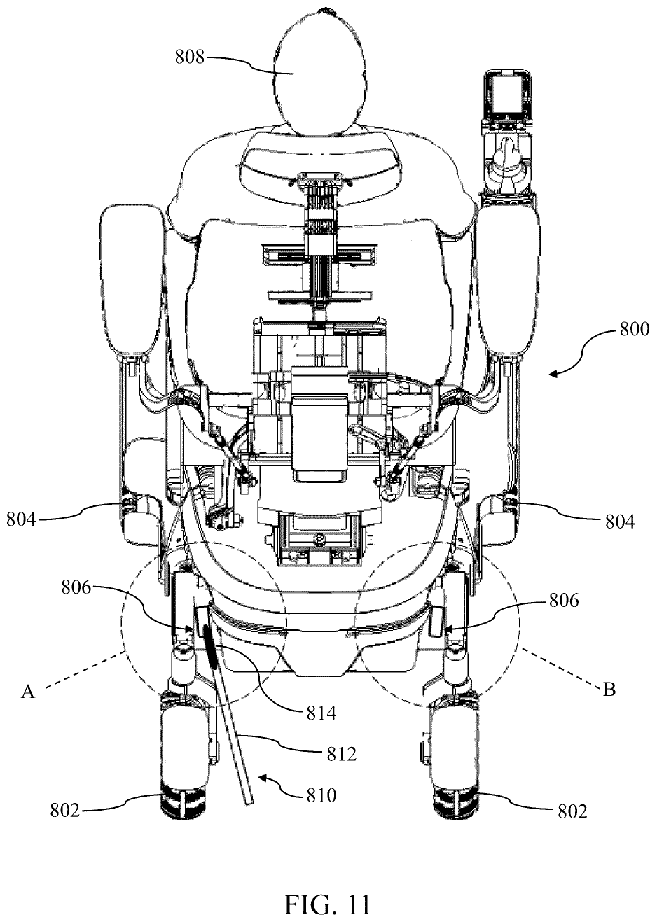

FIG. 11 illustrates an exemplary representation of image data that may be captured by a camera, such as a perception sensor 1030, (as shown in FIG. 1), positioned within the vehicle 1100. This camera may be configured to capture image data of a wheelchair 800, which includes rear wheels 802 and front wheels 804, and a passenger 808 seated therein. The image data further depicts a tiedown 810, which comprises a strap 812 and a hook 814, and a connection point 806 on the wheelchair 800. The connection point 806 may be specifically designed, such as a bracket, to receive the hook 814 of the tiedown 810. The camera may be positioned to provide a clear view of the area where the tiedown 810 is expected to engage with the connection point 806 on the wheelchair 800. In a preferred embodiment, the camera may be located straight up on the roof of the vehicle, positioned above and slightly back from the securement area. The captured image data may serve as input to the computing device 1010 for analysis.

The computing device 1010 may be configured to process the image data received from the camera to identify various components and determine their status. This processing may involve the application of machine learning algorithms. For instance, the computing device 1010 may utilize a trained machine learning model, such as a convolutional neural network (CNN) or other object detection algorithms. Exemplary models may include, but are not limited to, YOLO (You Only Look Once) for single object detection or SSD (Single Shot MultiBox Detector) variants. These models, which may be developed using programming languages such as Python, may be trained to identify the wheelchair 800 itself, the passenger 808, the specific connection points 806 on the wheelchair 800, and the components of the tiedown 810, including the strap 812 and the hook 814. The machine learning model may be trained on a diverse dataset of images of various wheelchair models, tiedowns, and securement scenarios, including both correctly and incorrectly engaged conditions. To enhance the robustness and accuracy of the model, the training data may be augmented through various techniques such as auto-orientation, conversion to grayscale, resizing, generating multiple outputs per training example, and applying random rotations and shears. Preprocessing steps may also include isolating specific regions of interest, applying static or dynamic cropping, and auto-adjusting image parameters. The identification of the connection point 806 may involve detecting predefined visual markers or structural features indicative of the designated attachment location. Similarly, the tiedown 810, or its connection member such as the hook 814, may be identified by its characteristic shape, color, or other visual attributes. The computing device may also be configured to scan the wheelchair to locate these securement points, or identify the configuration of the PMD (e.g., mid-drive power chair, manual wheelchair), and reference a stored database of PMD configurations and securement points to predict their expected locations, thereby improving the accuracy and speed of the verification process. Alternatively, the system may bypass PMD configuration detection and directly detect the securement points. The training of such machine learning models may be performed in a cloud computing environment, while inference (real-time detection) may occur in or outside of the vehicle.

Once the connection point 806 on the wheelchair 800 and the tiedown 810 (specifically, the hook 814) are identified within the image data, the computing device 1010 may be further configured to determine whether the tiedown 810 is engaged with the connection point 806. This determination may involve analyzing the spatial relationship between the identified hook 814 and the connection point 806. For example, the machine learning algorithm may assess if the hook 814 is physically inserted into, or properly latched onto, the connection point 806. For instance, the machine learning algorithm will be able to distinguish between detail A in FIG. 11, where the rear left tiedown hook 814 is engaged with the rear left connection point 806 on the wheelchair, and detail B, where the rear right tiedown hook (not shown) is not engaged with the rear right connection point 806 on the wheelchair. Making such an assessment may include comparing the detected state to known patterns of correct engagement. The system may analyze features such as the alignment, overlap, and proximity of the hook 814 with respect to the connection point 806. The system may identify the presence of specific visual cues (e.g., a closed latch indicator on the hook, or a change in the appearance of the connection point when engaged) to confirm proper engagement. The system may verify that the hook 814 is properly engaged with the connection point 806 and that it is hooked into the connection point in the proper direction. This direct detection of the physical connection may provide a higher level of confidence than merely measuring secondary characteristics. The computing system 1010 may also be configured to detect other conditions from the image data, such as whether the strap 812 is contacting, twisted, or bent around the wheels 802, or if the webbing is applied at a proper angle. An algorithm may be implemented to detect twisting by observing variations in the width of the webbing, setting a threshold for acceptable variation. For in-vehicle implementation, the computing device may comprise specialized hardware, such as an NVIDIA Jetson platform, which includes a Graphics Processing Unit (GPU) to handle the computational demands of real-time inference, achieving frame rates significantly higher than general-purpose CPUs or earlier microcontroller boards (e.g., Raspberry Pi, SDM32 which may yield only 5-6 frames per second). The GPU may be dedicated solely to performing inference tasks. The machine learning model's “weights” (parameters learned during training) may be loaded onto this GPU for efficient execution.

Based on this determination, the computing device 1010 may initiate various actions. If the tiedown 810 is determined to be engaged with the connection point 806, the computing device 1010 may cause a user interface 1020 to provide a status cue indicating a secured condition of the tiedown. This status cue may be visual (e.g., a green light, a colored highlight on a graphical representation of the wheelchair or tiedown on a display, or an augmented reality overlay on the live camera feed), auditory, or haptic feedback. The system may then provide an instructional cue for a subsequent securement step, guiding the user through the remaining process. Conversely, if the tiedown 810 is determined not to be engaged with the connection point 806, the computing device 1010 may cause the user interface 1020 to provide a status cue indicating an unsecured condition, along with a troubleshooting cue and an instructional cue for correcting the engagement. The troubleshooting cues may be overlaid on components that have been installed improperly or out of specification. The system may also withhold displaying a next instructional cue until any specific or all troubleshooting cues are addressed. In such a scenario, the computing device 1010 may also store the image data for documentation or training, or it may request and store an acknowledgement from an individual regarding the incorrect connection. Furthermore, to ensure safety, the computing device 1010 may apply an interlock preventing the operation of the vehicle 1100 until proper engagement is confirmed or an acknowledged override is performed (e.g., preventing release of parking brake, preventing use of transmission, preventing ignition) until proper engagement is confirmed or an acknowledged override is performed. This safety interlock is particularly vital in autonomous vehicle applications where a driver may not be present to perform a manual check. The computing device, such as the NVIDIA Jetson GPU, may communicate its determination to the vehicle's electronic control unit (ECU) via a CAN (Controller Area Network) controller. For example, if a securement condition is stable for a predetermined duration (e.g., 5 seconds), a message may be sent to the CAN controller, which then may be displayed on a vehicle screen and may enable the setting of interlocks by the ECU. This vision-based verification system may operate in conjunction with or independently of other sensing modalities described previously, offering a robust and intuitive method for ensuring proper wheelchair securement. The system may also detect and alert the operator about securement area obstructions, such as objects (backpacks) hanging from the wheelchair.

In alternative embodiments, to reduce the cost or complexity of the in-vehicle hardware, a simpler computing device (e.g., a microcontroller without a dedicated GPU) may be used. In such cases, the machine learning model may be a simplified custom-written algorithm instead of computationally intensive pre-trained models like YOLO. Alternatively, the image data processing and inference may be offloaded to a cloud computing environment via a wireless connection (e.g., Wi-Fi), where more powerful computing resources can perform the analysis and send feedback to the vehicle.

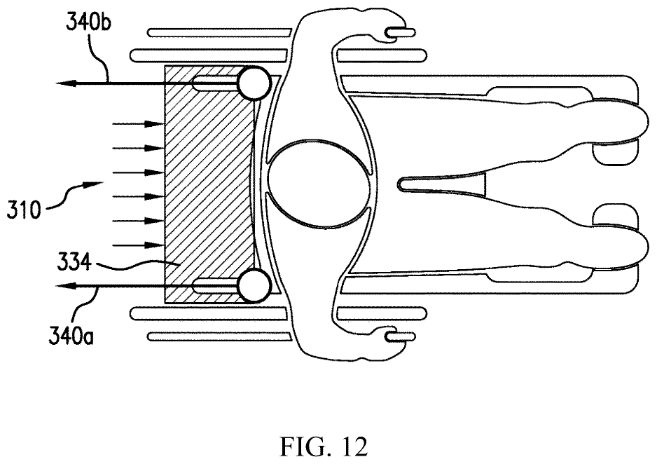

Referring now to FIG. 12, an exemplary two-point wheelchair securement system 310 described in more detail in U.S. Pat. No. 10,071,004 is depicted, which may be particularly advantageous for integration with the vision-based verification system described herein. This system 310 comprises a bumper 334 and two securement assemblies, identified as tiedowns 340a and 340b. As shown, the tiedowns 340a and 340b are positioned in a rear right side quadrant and a rear left side quadrant, respectively, of a wheelchair securement area, and are configured to secure a wheelchair 800 (as depicted in FIG. 11) using two points of attachment at the rear of the wheelchair 800. The bumper 334 is positioned to provide a compressive force against the rear of the wheelchair 800, cooperating with the tensile forces of the tiedowns 340a, 340b to restrain the wheelchair. To preload the wheelchair securement system, either the bumper 334 may be moveable toward and away from the wheelchair to induce tension in the tiedowns 340a, 340b, or the tiedowns 340a, 340b may include a tensioning mechanism to induce compression between the bumper 334 and the wheelchair. As noted in relation to FIG. 11, positioning a camera, such as perception sensor 1030, above and to the rear of the wheelchair 800 provides a clear and unobstructed view of the rear connection points 806 on the wheelchair 800, the tiedowns 340a, 340b (specifically their hooks 814), and the interaction between the bumper 334 and the wheelchair 800. This camera placement is particularly advantageous for this two-point rear securement configuration, as front connection points are often obscured by the passenger's legs, clothing, or the wheelchair seat, making reliable vision-based verification challenging for front securements.

The computing device 1010, utilizing image data from a camera positioned to capture the rear of the wheelchair 800, may be specifically configured to verify the proper securement of this two-point system 310. Machine learning algorithms, as previously described, may be employed to identify the rear connection points 806 on the wheelchair 800, the hooks 814 of the tiedowns 340a and 340b, and the bumper 334. The computing device 1010 may then determine, based on the image data, whether both tiedowns 340a and 340b are correctly engaged with their respective connection points 806 on the wheelchair 800. Concurrently, the system may determine whether the bumper 334 is in proper contact with the rear of the wheelchair 800. This contact verification may involve assessing the proximity and interaction between the bumper 334 and the wheelchair 800, ensuring a compressive force is applied as intended. If both tiedowns 340a and 340b are engaged and the bumper 334 is in contact, the system may provide a status cue indicating a fully secured condition. Conversely, if either tiedown is not engaged, or if the bumper is not in contact, the system may generate an alert, such as a troubleshooting cue or an instructional cue, to guide the user in correcting the improper securement. As described previously, such alerts may be visual, auditory, or haptic, and may be accompanied by an interlock preventing vehicle operation or automatic image capture for documentation. This integrated vision-based approach offers robust and reliable verification for two-point rear wheelchair securement systems with a bumper, enhancing safety and user confidence.

In other embodiments, a system may be configured to provide continuous monitoring of the securement integrity of a wheelchair during vehicle transit. This system may utilize one or more sensors, such as cameras, weight sensors, angle sensors, length sensors, or tension sensors, to obtain data indicative of various securement parameters. These parameters may include, but are not limited to, any of the sensed or measured parameters for tiedowns, occupant restraints, wheelchairs, or occupants as described elsewhere in this application. These may encompass characteristics of tiedowns (e.g., strap angles, strap lengths, strap tension, distance between tiedown anchor points), the wheelchair (e.g., location, dynamic characteristics, weight), and/or the occupant (e.g., location of an occupant belt on a passenger body, weight). Prior to vehicle departure, a controller may establish a “pre-departure baseline value” for one or more of these securement parameters. This baseline value represents the initial state of securement and may be implicitly accepted as acceptable by a vehicle operator upon commencing vehicle operation, meaning no express confirmation is necessarily required from the operator to establish this baseline. During vehicle operation, the controller may continuously or at least periodically obtain “current values” for the same securement parameter(s). The controller may then determine whether these current values remain within an “adaptive envelope” that is dynamically based on the established pre-departure baseline value. This adaptive envelope may be defined by lower and upper thresholds that allow for minor acceptable variations from the baseline, but flag significant deviations.

The system may also compare the pre-departure baseline value itself to a “predetermined envelope” defined by an ideal state or thresholds (e.g., industry standards like ISO) even before or after vehicle departure. If the pre-departure baseline initially falls outside this predetermined envelope, the controller may generate an alert, and in such cases, may apply an interlock preventing vehicle operation. This interlock may be released either by correcting the out-of-specification parameter or by receiving an acknowledgement from an individual. The controller may also store this baseline value and/or request an acknowledgement if it is outside the predetermined envelope. If, during transit, the current values fall outside the adaptive envelope (or alternatively, outside the predetermined envelope), the controller may generate an alert. This alert may be conveyed via a user interface and may comprise any of the visual, auditory, or haptic cues, status cues, instructional cues, directional cues, or troubleshooting cues previously described in this application. For instance, an alert may indicate that the wheelchair has shifted significantly from its initial position (e.g., “yawing to the right”) or that a tiedown has loosened. The adaptive envelope may be distinct from the predetermined envelope, potentially having more restrictive thresholds to detect subtle changes during transit. For example, an upper or lower threshold of the adaptive envelope may be more limiting than the corresponding threshold of the predetermined envelope. Upon detecting any out-of-envelope condition, the controller may store the current values, generate alerts, or apply interlocks to ensure the continuous safety of the mobility passenger.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A system for securing a wheelchair in a vehicle, the system comprising:
a camera configured to capture image data of the wheelchair in the vehicle;
at least one tiedown configured to secure the wheelchair; and
a computing device configured to:
receive the image data from the camera;
identify, from the received image data, a connection point on the wheelchair;
identify, from the received image data, the tiedown; and
determine, based on the received image data, whether the tiedown is engaged with the connection point on the wheelchair.

2. The system of claim 1, wherein the tiedown comprises a connection member and the computing device is configured to identify the tiedown by identifying, based on the received image data, the connection member on the tiedown.

3. The system of claim 2, wherein the connection member of the tiedown comprises a hook.

4. The system of claim 1, wherein the computing device is further configured to apply a machine learning algorithm to the received image data to identify the connection point on the wheelchair.

5. The system of claim 4, wherein the computing device is further configured to apply a machine learning algorithm to the received image data to identify the tiedown.

6. The system of claim 5, wherein the connection point on the wheelchair comprises a bracket.

7. The system of claim 5, further comprising a user interface coupled to the computing device.

8. The system of claim 7, wherein the computing device is further configured to, upon determining that the tiedown is engaged with the connection point, cause the user interface to provide a status cue indicating a secured condition of the tiedown.

9. The system of claim 7, wherein the computing device is further configured to, upon determining that the tiedown is not engaged with the connection point, cause the user interface to provide a status cue indicating an unsecured condition of the tiedown.

10. The system of claim 9, wherein the status cue comprises an overlay on a representation of at least one of the wheelchair and the tiedown.

11. The system of claim 10, wherein the representation is the image data from the camera.

12. The system of claim 9, wherein the status cue comprises auditory or haptic feedback.

13. The system of claim 7, wherein the computing device is further configured to, upon determining that the tiedown is engaged with the connection point, cause the user interface to provide an instructional cue for a subsequent securement step.

14. The system of claim 7, wherein the computing device is further configured to, upon determining that the tiedown is not engaged with the connection point, cause the user interface to provide a troubleshooting cue indicating an incorrect engagement of the tiedown with the connection point.

15. The system of claim 7, wherein the computing device is further configured to, upon determining that the tiedown is not engaged with the connection point, cause the user interface to provide an instructional cue for correcting engagement between the tiedown and the connection point.

16. The system of claim 5, wherein the computing device is further configured to, upon determining that the tiedown is not engaged with the connection point, apply an interlock preventing an operation of the vehicle.

17. The system of claim 5, wherein the computing device is further configured to, upon determining that the tiedown is not engaged with the connection point, store the image data.

18. The system of claim 5, wherein the computing device is further configured to, upon determining that the tiedown is not engaged with the connection point, request, receive, and store an acknowledgement of an incorrect connection.

19. A vehicle comprising a wheelchair securement system and the system of claim 5.

20. A method for securing a wheelchair in a vehicle, the method comprising:
receiving, by a computing device, image data of the wheelchair in the vehicle;
identifying, by the computing device from the received image data using a machine learning algorithm, a connection point on the wheelchair;
identifying, by the computing device from the received image data using a machine learning algorithm, a tiedown; and
determining, by the computing device based on the received image data, whether the tiedown is engaged with the connection point on the wheelchair.
